(19) United States
(12) Patent Application Publication
(10) Pub. No.: US 2025/0151735 A1
(43) Pub. Date: May 15, 2025

(54) FILLED FOOD PRODUCTS AND METHODS OF PREPARING SAME

(71) Applicant: YB Foods LLC, Long Valley, NJ (US)

(72) Inventors: Henry V. IZZO, Long Valley, NJ (US); Martin G. MIGTON, Ledgewood, NJ (US); Norman D. ALWORTH, Hackettstown, NJ (US)

(73) Assignee: YB Foods LLC, Long Valley, NJ (US)

(21) Appl. No.: 18/838,564

(22) PCT Filed: Feb. 21, 2023
(86) PCT No.: PCT/US2023/013515

§ 371 Date: Aug. 14, 2024

Related U.S. Application Data
(60) Provisional application No. 63/268,250, filed on Feb. 18, 2022.

(51) Int. Cl. A21D 13/31; A21D 13/37; A21D 13/38

(52) U.S. Cl. CPC A21D 13/31; A21D 13/37; A21D 13/38

(57) ABSTRACT

The present invention is directed to heat stable food ingredient compositions, ready to eat substantially sealed filled food products incorporating them, and methods of manufacturing said food products. Such food ingredient compositions include fillings which may be incorporated within one or more other components of a complex food prior to any of a variety of cooking steps required to manufacture various ready to eat filled food products from such components.

### CROSS-REFERENCE TO RELATED APPLICATIONS

This application claims priority to U.S. Provisional Application No. 62/268,250, filed Feb. 18, 2022. The entire content of the application referenced above is hereby incorporated by reference herein.

### BACKGROUND

Foods manufactured by baking, frying, or extrusion are a significant and growing market across the globe. Many such food products incorporate fillings and/or toppings to add variety and versatility for consumers and manufacturers alike. Such components provide added flavor, texture, and overall sensory interest for the consumer. As such, they provide flexibility to manufacturers seeking to offer products targeted to different consumer preferences and maximize the scope of the market for their products.

Unfortunately, many fillings and toppings are not heat stable at the temperatures required in many food manufacturing processes. These include many fat-based, carbohydrate-based, or dairy-based compositions, the latter including many popular traditional cheese compositions. Among other problems, heat labile compositions can melt, scorch or even vaporize during thermal processing, ruining a product's flavor, texture, color and other sensory attributes. In the case of fillings vaporization can also cause a product to burst and leak during or after processing, adversely impacting product quality. This loss of filling from the product can result not only in reduced product yield but also burning and scorching of food on manufacturing equipment leading to increased costs due to the need for more involved cleaning and longer changeovers from one batch to the next.

For these reasons, in many instances the incorporation of fillings or application of toppings is limited to one or more separate unit operations following thermal processing (post bake, post fry, etc.). Thus, most products are filled, sandwiched, bottomed, or topped with these food systems after any heating steps to reduce or eliminate these issues. In most cases this is a complex task and adds one or more unit operations to the manufacturing process. The baking or frying process generates many individual pieces to be subsequently filled or topped. Any extra steps must often be done in a particular orientation relative to each piece of product undergoing manufacturing. This necessitates retaining or regaining control of the orientation of numerous individual pieces before filling or topping them, eroding process efficiency and driving up manufacturing costs.

Forming coextrusion followed by baking is known in the art and is currently used to produce a limited number of filled snack products, including for example filled pretzel products, which are primarily peanut butter-based as such fillings are robust to the thermal processing required. Unfortunately, such fillings afford limited flexibility to manufacture filled products with different sensory attributes This limited flexibility also hinders the ability to manufacture products addressing other dietary needs such as allergen-free, low-sugar, and/or vegan or plant-based products.

There remains a need for heat stable compositions useful for creating a variety of different fillings, both sweet and savory, which can be efficiently incorporated into food products tailored to a range of sensory attributes, including but not limited to different flavors, aromas, textures, and mouthfeel. This need likewise extends to the flexibility to afford products for consumers with dietary requirements arising from a variety of health conditions or lifestyle concerns.

### SUMMARY

Applicants have discovered heat stable compositions useful in the creation of a variety of different fillings, both sweet and savory, which can be efficiently incorporated into a multitude of different food products tailored to sensory attributes and dietary restrictions arising from consumers' preferences, health conditions, and lifestyle choices. These compositions improve manufacturing efficiencies by obviating the need for additional unit operations due to their ability to undergo thermal processing necessary for other components of complex food products, such as a variety of types of doughs employed in creating the outer shells or substrates of filled or topped food products.

The present invention is directed to heat stable food ingredient bases, food ingredient compositions made with such bases, and the food products incorporating them. The present invention is also directed to methods of using said food ingredient bases and food ingredient compositions, and of manufacturing said food products. Such food ingredient compositions may be fillings (including centers, layers and sandwiches) or toppings (including coatings, drizzles, dips and sprays) which may be incorporated with or applied to one or more components of a complex food product prior to, concurrent with, or following any thermal processing step required to manufacture the food product from such components.

### BRIEF DESCRIPTION OF THE DRAWINGS

FIG. 1 shows a process flow diagram for manufacturing a variety of enclosed filled products according to certain embodiments of the invention.

FIG. 2A shows a side view of a nugget type enclosed filled product according to certain embodiments of the invention.

FIG. 2B shows a side view of a bar or rod type enclosed filled product according to certain embodiments of the invention.

FIG. 2C shows a side view of a segmented bar or rod type enclosed filled product according to certain embodiments of the invention.

FIG. 3A is a photograph of a vegan peanut butter control sample prior to baking.

FIG. 3B is a photograph of the sample of FIG. 3A following baking at 500° F. for 15 minutes.

FIG. 3C is a photograph of the baked sample of FIG. 3B following agitation.

FIG. 4A is a photograph of a dairy-based sample prior to baking.

FIG. 4B is a photograph of the sample of FIG. 4A following baking at 500° F. for 15 minutes.

FIG. 4C is a photograph of the baked sample of FIG. 4B following agitation.

FIG. 5A is a photograph of a 50% fat:50% plant flour sample prior to baking.

FIG. 5B is a photograph of the sample of FIG. 5A following baking at 500° F. for 15 minutes.

FIG. 6 is a photograph of a 20% fat:80% plant flour sample prior to baking.

FIG. 7A is a photograph of a 30% fat:70% plant flour sample prior to baking.

FIG. 7B is a photograph of a 40% fat:60% plant flour sample prior to baking.

FIG. 7C is a photograph of a 45% fat:55% plant flour sample prior to baking.

FIG. 7D is a photograph of a 50% fat:50% plant flour sample prior to baking.

FIG. 7E is a photograph of a 60% fat:40% plant flour sample prior to baking.

FIG. 7F is a photograph of a 70% fat:30% plant flour sample prior to baking.

FIG. 8A is a photograph of a 30% fat:70% plant flour sample following baking at 500° F. for 15 minutes.

FIG. 8B is a photograph of a 40% fat:60% plant flour sample following baking at 500° F. for 15 minutes.

FIG. 8C is a photograph of a 45% fat:55% plant flour sample following baking at 500° F. for 15 minutes.

FIG. 8D is a photograph of a 50% fat:50% plant flour sample following baking at 500° F. for 15 minutes.

FIG. 8E is a photograph of a 60% fat:40% plant flour sample following baking at 500° F. for 15 minutes.

FIG. 8F is a photograph of a 70% fat:30% plant flour sample following baking at 500° F. for 15 minutes.

FIG. 9A is a photograph of a 30% fat:70% plant flour sample following baking at 500° F. for 15 minutes and subsequent stirring of the sample.

FIG. 9B is a photograph of a 40% fat:60% plant flour sample following baking at 500° F. for 15 minutes and subsequent stirring of the sample.

FIG. 9C is a photograph of a 45% fat:55% plant flour sample following baking at 500° F. for 15 minutes and subsequent stirring of the sample.

FIG. 9D is a photograph of a 50% fat:50% plant flour sample following baking at 500° F. for 15 minutes and subsequent stirring of the sample.

FIG. 9E is a photograph of a 60% fat:40% plant flour sample following baking at 500° F. for 15 minutes and subsequent stirring of the sample.

FIG. 9F is a photograph of a 70% fat:30% plant flour sample following baking at 500° F. for 15 minutes and subsequent stirring of the sample.

FIG. 10A is a photograph of the 30% fat:70% plant flour sample shown in FIG. 9A following cooling to room temperature.

FIG. 10B is a photograph of the 40% fat:60% plant flour sample shown in FIG. 9B following cooling to room temperature.

FIG. 10C is a photograph of the 45% fat:55% plant flour sample shown in FIG. 9C following cooling to room temperature.

FIG. 10D is a photograph of the 50% fat:50% plant flour sample shown in FIG. 9D following cooling to room temperature.

FIG. 10E is a photograph of the 60% fat:40% plant flour sample shown in FIG. 9E following cooling to room temperature.

FIG. 10F is a photograph of the 70% fat:30% plant flour sample shown in FIG. 9F following cooling to room temperature.

FIG. 11A is a photograph of the 30% fat:70% plant flour sample shown in FIG. 10A.

FIG. 11B is a photograph of the 40% fat:60% plant flour sample shown in FIG. 10B following sample agitation.

FIG. 11C is a photograph of the 45% fat:55% plant flour sample shown in FIG. 10C following sample agitation.

FIG. 11D is a photograph of the 50% fat:50% plant flour sample shown in FIG. 10D following sample agitation.

FIG. 11E is a photograph of the 60% fat:40% plant flour sample shown in FIG. 10E following sample agitation.

FIG. 11F is a photograph of the 70% fat:30% plant flour sample shown in FIG. 10F following sample agitation.

FIG. 12A is a photograph of a 45% fat:55% chickpea flour sample at room temperature.

FIG. 12B is a photograph of a 45% fat:55% field pea flour sample at room temperature.

FIG. 12C is a photograph of a 45% fat:55% oat flour sample at room temperature.

FIG. 12D is a photograph of a 45% fat:55% peanut flour sample at room temperature.

FIG. 12E is a photograph of a 45% fat:55% white lentil flour sample at room temperature.

FIG. 13A is a photograph of a 45% fat:55% amaranth flour sample at room temperature.

FIG. 13B is a photograph of a 45% fat:55% pumpkin seed flour sample at room temperature.

FIG. 13C is a photograph of a 45% fat:55% sunflower seed flour sample at room temperature.

FIG. 13D is a photograph of a 45% fat:55% almond flour sample at room temperature.

FIG. 13E is a photograph of a 45% fat:55% cashew flour sample at room temperature.

FIG. 13F is a photograph of a 45% fat:55% red lentil flour sample at room temperature.

FIG. 13G is a photograph of a 45% fat:55% tapioca flour sample at room temperature.

FIG. 14A is a photograph of a 45% fat:55% brown rice flour sample at room temperature.

FIG. 14B is a photograph of a 45% fat:55% buckwheat flour sample at room temperature.

FIG. 14C is a photograph of a 45% fat:55% golden corn flour masa harina sample at room temperature.

FIG. 14D is a photograph of a 45% fat:55% quinoa flour sample at room temperature.

FIG. 14E is a photograph of a 45% fat:55% white rice flour sample at room temperature.

FIG. 15A is a photograph of a 45% fat:55% flour sample at room temperature wherein the flour is a mixture of 75% chickpea flour and 25% white lentil flour.

FIG. 15B is a photograph of a 45% fat:55% flour sample at room temperature wherein the flour is a mixture of 75% chickpea flour and 25% red lentil flour.

FIG. 15C is a photograph of a 45% fat:55% flour sample at room temperature wherein the flour is a mixture of 75% chickpea flour and 25% sunflower seed flour.

FIG. 15D is a photograph of a 45% fat:55% flour sample at room temperature wherein the flour is a mixture of 75% chickpea flour and 25% tapioca flour.

FIG. 15E is a photograph of a 45% fat:55% flour sample at room temperature wherein the flour is a mixture of 75% chickpea flour and 25% brown rice flour.

FIG. 15F is a photograph of a 45% fat:55% flour sample at room temperature wherein the flour is a mixture of 75% chickpea flour and 25% golden corn flour masa harina.

FIG. 16 is a photograph of three of the 45% fat:55% plant flour samples made using palm oil wherein the flour used was chickpea flour (left), white lentil flour (center) and a blend of 75% chickpea flour: 25% white lentil flour (right).

FIG. 17 is a photograph of a sealed pillow and a cross section of a peanut butter filled pretzel snack food product of the prior art.

FIG. 18 is a photograph of a sealed pillow and a cross section of a vegan baked cheese filled pretzel snack food product according to one embodiment of the present invention.

FIG. 19 is a photograph of a sealed pillow and a cross section of a vegan garlic & herb filled pretzel snack food product according to one embodiment of the present invention.

FIG. 20 is a photograph of a sealed pillow and a cross section of a vegan chipotle filled pretzel snack food product according to one embodiment of the present invention.

### DETAILED DESCRIPTION

The present invention addresses the need for enhanced flexibility in the efficient manufacturing of food products. Although a wide variety of fillings and toppings can be used to broaden the versatility of such products with respect to formats, flavors, textures and other organoleptic properties, unfortunately, the majority of these must be applied in a separate step following any required thermal processing for baked, fried, or otherwise cooked food products. The present invention arises from the recognition that the inability of many filling and topping compositions to undergo heat treatment is the result of thermal instability of one or more components of the ingredients therein. Removal of any ingredients which are problematic per se, or mutual isolation of ingredients which are problematic when present in combination in such formulations provides a means to create compositions which can undergo thermal processing required for any associated components, such as doughs, of complex food products.

In the case of filled snack products, nut butter-based fillings, such as peanut butter and almond butter, have gained wide acceptance as fillings from manufacturers and consumers alike. These bases possess the requisite thermal stability and other physicochemical properties rendering them useful for efficient manufacturing processes such as forming coextrusion and baking. Unfortunately, these bases are not compatible with the variety of flavor and texture profiles possible for many fillings. They also cannot be used for products targeted to consumers with allergy or other dietary restrictions. Conversely, non nut butter-based fillings are often incompatible with heat processing and must be applied to individual pieces of product after any baking or cooking step occurs. Such fillings may also contain ingredients which are non-vegan and thus unacceptable to many consumers pursuing modern trends for dietary or sustainability purposes.

The present invention can be used to produce vegan and non-vegan options in a wide array of sweet and savory flavors including vegan cheese or dairy free fillings or toppings. This allows for a forming/filling process prior to or commensurate with a heat processing step and packaging of said products ready for distribution and consumption, eliminating the need for any post bake filling or application steps and their associated process inefficiencies. The invention can be used to overcome issues with traditional cheese fillings, carbohydrate-based fillings, and fat-based fillings.

The present invention is more fully described by way of the following definitions:

As used herein, the term “caustic” means a basic solution such as food grade lye or baking soda. The term “caustic treatment” means a step in the pretzel making process wherein a dough is treated, by any of a variety of means including but not limited to bathing, dipping, or spraying, with a caustic to provide the distinct brown color, surface texture, and alkaline flavor characteristic of a pretzel.

As used herein, the term “cold forming” means to shape the filling and dough either separately or simultaneously, without heating to cook or shearing to cook in the process. Nevertheless, reduced heating or shear may be applied to aid processing, such as conveying the materials which are to be cold formed. A common form of such simultaneous shaping is via forming coextrusion in which a filling is disposed within an edible material, such as a dough, in a filled rope. The term “cold formed” is an adjective applied to an immediate or downstream product of cold forming.

As used herein, the term “cooking” means the practice of heating a whole food or a combination or mixture of ingredients to make it more safe, edible, and enjoyable for consumption. Cooking may occur at moderate conditions from about 300° F. to about 375° F., at hot oven conditions from about 376° F. to about 450° F., and at fast conditions at above 450° F. Cooking may be baking by convection or air impingement heating, direct heating, or conductive heating, or alternatively frying in oil or fat.

As used herein, the term “crimping” means the sealing of the edible material surrounding a component of a filling, for example a dough, through compression. The term “crimped” means that the edible material is sealed with respect to the location on the edible material where crimping occurred.

As used herein, the term “crunchy” applied to a food means a food that is firm and makes a short, loud, low-pitched noise when eaten or pressed. Such a food usually has a dense texture, undergoes a series of fractures in the mouth, and is chewed through use of the molars, providing a sense of substance and satisfaction to the consumer. Examples would be pretzels or crunchy dough based baked products with a substantial thickness, layer or shell. This is in contrast to something that is crispy that fractures quickly and easily while emitting a high-pitched sound. Examples of crispy products would be cooker extruded puffed products or lightly fried potato chips.

As used herein, the term “dough” means any thick malleable mixture of flour and liquid used in baking, frying, or other cooking methods to produce breads, pastries, snacks, or other foods. A dough may include one or more compositions which may or may not be known in the art, including but not limited to a pretzel dough, a cracker dough, a cookie dough, a masa or corn-based dough, a tortilla dough, a pastry dough, a bread dough, a gluten free dough, a potato-based or containing dough, a legume-based or containing dough, a cassava-based or containing dough, or a dough based on or containing any other flour formulation capable of producing a shell. A dough may also incorporate one or more inclusions such as whole grains, dried vegetables, dried fruits, or chocolate or other flavored pieces or morsels.

As used herein the term “drying” means subjecting a cooked article to a more moderate temperature than cooking for a period sufficient to reduce the moisture content of the article to a desired target. Additionally, “drying” includes other methods known in the art for reducing moisture content, including, for example, microwave or radiofrequency drying or dehydration.

As used herein, the term “shell” or “outer shell” means the outer layer of a food product prepared by cooking an edible material such as a dough corresponding to the desired shell. Depending upon the type of dough used and the treatment applied, a shell according to the present invention may include but not necessarily be limited to a cookie shell, including but not limited to a shortbread cookie shell, a chocolate cookie shell, a vanilla cookie shell, a butter cookie shell, a gingerbread cookie shell, a molasses cookie shell, a cracker shell, including but not limited to a butter cracker shell, a saltine cracker shell, a vegetable cracker shell, a graham cracker shell, a sweet multigrain shell or savory multigrain shell, a tortilla shell, a cocoa flavored shell, or a pretzel shell. The shell may also incorporate one or more inclusions such as whole grains, dried vegetables, dried fruits, or chocolate or other flavored pieces or morsels. In preferred embodiments the shell or outer shell is crunchy as defined herein.

As used herein, the terms “enclose” or “seal” mean to surround one component of a food product, such as a filling, entirely within another edible material, such as a dough, which will form a second component of a food product, such as a shell.

As used herein, the term “substantially enclose” or “substantially seal” means to surround one component of a food product, such as a filling, entirely within another edible material, such as a dough, which will form a second component of a food product, such as a shell, with or without one or more venting pinholes or slits applied to the edible material. Accordingly, a substantially sealed article encompasses both a sealed article and a sealed article with one or more venting pinholes or slits in the outer component.

As used herein, the term “flour” means any granular, powdered or melted solid component of any edible material, including but not limited to sugars, starches, fiber, and proteins. The term “plant flour” means any granular, powdered or melted solid component of any plant material, including but not limited to sugars, starches, fiber, and proteins.

As used herein, the term “leguminous flour” means a flour obtained by grinding any part of a plant from the Fabaceae family, including legumes as well as their edible seeds known as pulses.

As used herein, the term “seed flour” means a flour obtained by grinding any part of the seed of a plant from the Amaranthaceae family or the Cucurbitaceae family, or a flour obtained by grinding any part of sunflower seeds.

As used herein, the term “tree nut flour” means a flour obtained by grinding any part of a tree nut including but not limited to almonds, beech nuts, butternuts, Brazil nuts, cashews, candlenuts, chestnuts, coconuts, hazelnuts, hickory nuts, lychee, macadamia nuts, pecans, pine nuts, pistachios, shea nuts, and walnuts.

As used herein, the term “secondary flour” means a flour or flour mixture that is added to or combined with another flour or mixture of flours within a filling or filling base. A secondary flour is typically used to expand the variety of organoleptic, nutritional, or other dietary properties of the filling or filling base.

As used herein, the term “heat stable” means capable of withstanding the thermal processing typically associated with food manufacturing processes employing thermal treatment, for example baking, frying, roasting, or otherwise cooking, including partial (for example, par-baked) or full processes, as modeled by the ability of the composition to withstand exposure to a temperature of 500° F. for any duration up to 15 minutes without scorching or burning significantly impacting the organoleptic quality of the composition.

As used herein, the term “ready-to-eat” means a food that will not require further preparation through, for example, cooking or otherwise heating or reheating, prior to consumption. Although certain consumers may find it desirable to heat such a food, it is not necessary. Within the limits of its shelf life, such a food is safe for consumption immediately.

As used herein, the term “solid fat” means a fat that is solid at room temperature (from about 15° C. (59° F.) to about 25° C. (77° F.), including animal fats such as lard and beef tallow, dairy fats such as butter, and plant-based fats such as coconut oil, palm oil, and cocoa butter, and shortening, and hydrogenated oils.

### EMBODIMENTS

In one embodiment this invention is directed to heat stable compositions that can be used as bases for fillings or toppings in food products that undergo cooking during manufacturing. In this embodiment, the invention is drawn to a filling or topping base comprising at least one fat or oil and at least one plant flour. In a preferred embodiment, the filling or topping base further comprises at least one emulsifier. Such emulsifiers may be liquid or solid and may be derived from a variety of sources. In a preferred embodiment such emulsifiers are derived from plant sources, and in a particularly preferred embodiment are selected from soy lecithin or sunflower lecithin.

Such fats or oils may be solid, semisolid, or liquid at room temperature and may be derived from plant or animal origins. In a preferred embodiment the only or primary fat or oil present is plant based. In a more preferred embodiment the only or primary fat or oil present is a solid fat as defined herein. In a particularly preferred embodiment the only or primary fat or oil present is palm oil or coconut oil.

The ratio of total fat content (“fat”, equivalent to solid fat, oil and emulsifier) to flour present in the base composition can range on a weight percent basis from about 30% fat:70% flour to about 70% fat:30% flour. In a more preferred embodiment such ratio can range from about 40% fat:60% flour to about 60% fat:40% flour. In a particularly preferred embodiment such ratio can range from about 40% fat:60% flour to about 50% fat:50% flour.

In a preferred embodiment the only or primary plant flour present is selected from the group consisting of a leguminous flour, a seed flour, a tree nut flour, tapioca flour, amioca, or a grain flour. More preferably the only or primary plant flour present is selected from the group consisting of chickpea flour, pea flour, oat flour, peanut flour, white lentil flour, amaranth flour, pumpkin seed flour, sunflower seed flour, almond flour, cashew flour, red lentil flour, tapioca flour, amioca, and mixtures thereof. In a particularly preferred embodiment the only or primary plant flour present is selected from the group consisting of chickpea flour, pea flour, oat flour, peanut flour, and white lentil flour. In an even more preferred embodiment the only or primary plant flour is selected from the group consisting of chickpea flour, pea flour and oat flour. In an even more preferred embodiment the only or primary plant flour present is chickpea flour.

In another embodiment, the invention is directed to a heat stable filling or topping composition comprising a filling or topping base as described above as well as one or more herbs, spices, seasonings, colors and/or flavors (the minor ingredients). Such additional ingredients may be any traditionally found in popular sweet or savory snacks or may include unique combinations. In a preferred embodiment the filling or topping composition contains about 30% to about 70% by weight of fat or oil (including any emulsifiers), about 5% to about 67.5% by weight of flour, and about 2.5% to about 25% by weight of minor ingredients. In a more preferred embodiment the filling or topping composition contains about 30% to about 70% by weight of fat or oil (including any emulsifiers), about 19.5% to about 65.5% by weight of flour, and about 4.5% to about 10.5% by weight of minor ingredients.

The ratio of total fat content (“fat”, equivalent to solid fat, oil and emulsifier) to flour present in the filling or topping composition can range on a weight percent basis from about 30% fat:70% flour to about 70% fat:30% flour. In a more preferred embodiment such ratio can range from about 40% fat:60% flour to about 60% fat:40% flour. In a particularly preferred embodiment such ratio can range from about 40% fat:60% flour to about 50% fat:50% flour.

In a preferred embodiment the filling or topping composition is prepared by combining the filling or topping base with the minor ingredients. This advantageously allows for delayed differentiation so that one filling or topping base composition can be used efficiently to prepare a variety of filling or topping compositions. However, the invention also contemplates the preparation of fillings or toppings having the same ingredient compositions prepared via other orders in which the ingredients may be combined as well.

In certain embodiments, the water content of the filling prior to cooking is less than or equal to 20%. In more preferred embodiments, the water content of the filling prior to cooking is less than or equal to 16%. In even more preferred embodiments, the water content of the filling prior to cooking is less than or equal to 13%. In even preferred embodiments, the water content of the filling prior to cooking is less than or equal to 10%. In particularly preferred embodiments, the water content of the filling prior to cooking is less than or equal to 7.5%.

In certain embodiments, the water content of the filling prior to cooking is greater than or equal to 1%. In more preferred embodiments, the water content of the filling prior to cooking is greater than or equal to 3%. In even more preferred embodiments, the water content of the filling prior to cooking is greater than or equal to 5%. In even preferred embodiments, the water content of the filling prior to cooking is greater than or equal to 6%. In particularly preferred embodiments, the water content of the filling prior to cooking is greater than or equal to 6.5%.

In other embodiments the invention is directed to filled food products made by cooking a dough substantially sealed around a filling composition of the present invention. In a preferred embodiment the food product is a substantially sealed filled food product made via forming coextrusion of the food dough with a filling composition of the invention followed by cooking via baking or frying.

In certain embodiments the filled food product has a water content of less than or equal to 3.5%. In more preferred embodiments the filled food product has a water content of less than or equal to 3%. In even more preferred embodiments the filled food product has a water content of less than or equal to 2.5%.

In certain embodiments the filled food product has a water content of greater than or equal to 0.5%. In more preferred embodiments the filled food product has a water content of greater than or equal to 1%. In even more preferred embodiments the filled food product has a water content of greater than or equal to 1.5%.

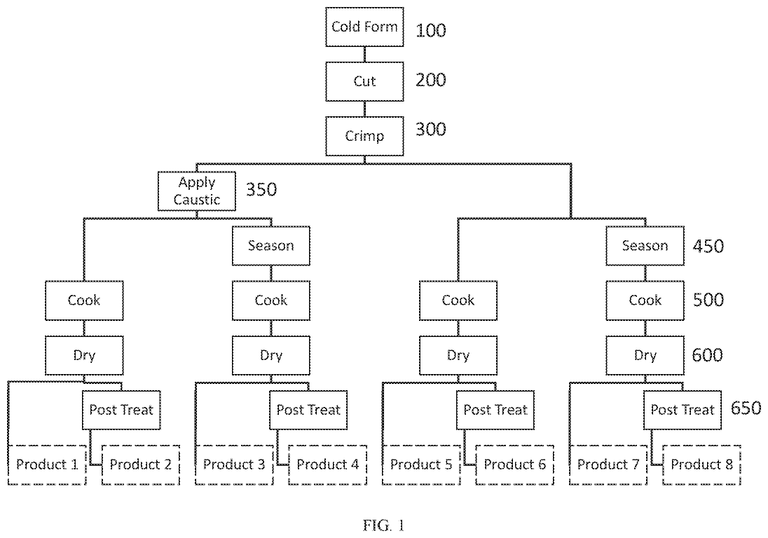

In other embodiments this invention is directed to methods of using the heat stable compositions to manufacture a variety of substantially sealed food products having cooked fillings. The manufacturing process and product variations to which several embodiments of the present invention are directed can be understood with reference to the process flow diagram in FIG. 1. A filling according to the present invention is disposed within an edible material such as a dough via cold forming (100). In the case of forming coextrusion, cold forming results in a filled rope having an edible material such as a dough annularly disposed about a filling. The filled rope is cut (200) into pieces at any angle to the main axis of the filled rope, and the ends so formed are crimped (300) either simultaneously with the cutting process by use of a specialized cutting blade or at a time thereafter prior to cooking to substantially enclose the filling within the dough.

A caustic is optionally applied (350) to obtain a product with a pretzel shell, while products with other types of shells, such as cracker shells, may be made by foregoing this step. The pieces are optionally seasoned (450), for example using salt or sugar. The pieces then undergo cooking (500) and drying (600) to a desired moisture content. The resulting product is optionally treated (650), for example to coat with a seasoning, enrobe the piece in a desired layer such as a confectionery coating, chocolate, an icing, or the like.

The optional application of a caustic results in Products 1 through 4, each having a pretzel shell, while foregoing this step results in Products 5-8, having non-pretzel type shells, such as a cracker, a cookie, a corn-based shell, a tortilla, or the like. The optional application of a seasoning before cooking, for example salting, results in Products 3, 4, 7, and 8, each having a shell with a baked seasoning. The optional application of a treatment after cooking results in Products 2, 4, 6, or 8, each representing a modified product that has been, for example, coated, dusted, or enrobed using one or more ingredients not exposed to the cooking step.

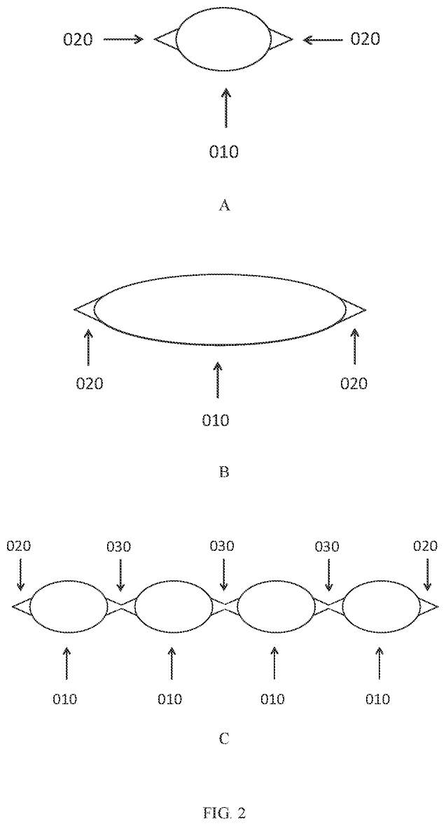

Each of Products 1 through 8 represents a combination food with a filling according to the present invention substantially enclosed within an outer shell. FIG. 2 illustrates a side view of various products from these embodiments, showing a filled cavity (010) in which the outer shell surrounds the cooked filling, and at least one end (020) which has been cut and crimped to substantially seal the filling within the dough during processing. These enclosed food products include but are not necessarily limited to nugget type products, as shown in FIG. 2A, having a length roughly equal to or slightly greater than their width, as well as rod or bar type products, as shown in FIGS. 2B and 2C, having greater length relative to their width.

Such rod or bar type products may be segmented, as shown in FIG. 2C, by, for example, crimping the rod or bar (030) to partition the filling into discrete filled cavities (010) without completely cutting the rod or bar into pieces so that a consumer may snap pieces corresponding to one or more filled cavities (010) off the rod or bar at the time the product is consumed.

It will be evident to those of ordinary skill in the art that cold forming, cutting, and crimping may occur in various orders and either in separate or combined steps. In instances wherein the edible material into which the filling will be placed is a dough, for example, crimping may occur following cutting or simultaneously therewith via use of special cutting blades known in the art. As another example, cold forming may involve coextrusion of the filling within the dough to form a filled rope which may then be cut or crimped. In forming coextrusion, the dough and filling are shaped simultaneously.

The invention also contemplates processes in which the forming of each component occurs separately. For example, cold forming may also involve depositing a mass of filling as a bolus, a shaped tube, a ribbon, or the like onto a flat piece of dough, which may itself be precut, and folding the dough around the filling and crimping or cutting and crimping as necessary to enclose the filling within the dough to arrive at the desired product format. As an additional example, cold forming may involve depositing a filling onto a piece of dough, overlaying the filling and dough with another piece of dough, and crimping to enclose the filling. As an additional example, cold forming may involve injecting a filling into a piece of dough.

Additional means of forming a substantially sealed filled article will be readily apparent to those skilled in the art. Accordingly, these examples, as well as the process of FIG. 1, are illustrative of certain embodiments and not intended to limit the manner in which products may be prepared according to the present invention.

### Sample Evaluation

In those embodiments of the invention directed to filling bases, fillings, and filled food products manufactured by forming coextrusion and subsequent cooking, such bases and fillings must meet acceptability criteria to ensure they are suitable for the processing involved. Fillings for baked coextruded products must possess certain physicochemical properties rendering them not only amenable to the manufacturing process, but also capable of producing a substantially sealed, high quality baked food product. The criteria to evaluate filling bases and fillings for coextrusion and throughout the baking process are outlined in Table 1.

TABLE 1

| Process | |
|---|---|
| Stage | Requirements |
| Pre - Bake | Ability to mix dry ingredients with fat and emulsifier |
| | Minimal separation of oil phase from dry ingredients |
| | Ability to convey/pump filling into uniform co-extruded ropes |
| Baking | Thermal stability to model (500° F. for 15 minutes in |
| | a standard kitchen oven) of thermal treatment applied |
| | within coextruded pieces during manufacturing as |
| | determined by minimal browning, no scorching or burning |
| | Minimal to no leakage of filling from co-extruded shell |
| After | Minimal oil phase separation after baking |
| Baking | Minimal to no leakage of filling from co-extruded shell |
| | Filling sets up in shell, ideally prior to packaging to |
| | ensure product quality |

During the mixing and forming process prior to baking, the ingredients of the filling should be able to be mixed to the desired consistency with minimal to no separation of the lipid phase from any dry ingredients. Also important is the need to form and convey the filling into coextruded filled ropes within the dough or other edible composition which will form the outer shell of the product. During baking, the filling must withstand any necessary thermal treatment to avoid browning, scorching or burning which would adversely impact flavor, color, texture, and mouthfeel of the filling center in the final product. The benchtop experiments conducted herein modeled the temperatures necessary with treatment at 500° F. for 15 minutes in a standard kitchen oven.

Under actual manufacturing conditions, in addition to the adverse impact of temperature on the filling per se, leakage of the filling from the shell by random perforation or other compromise of the shell's integrity must also be avoided. Such leakage should also be avoided following baking as and after the product cools and is packaged.

In certain embodiments in which cooking is performed by conductive heating or convective heating in air in a controlled product orientation, the risk of heating to the integrity of the shell may optionally be managed by introducing one or more pinholes or slits to allow venting or expansion. Such pinholes or slits can avoid a buildup of pressure which could damage the shell at another location and may be useful to keep certain filling formulations from bursting the crimped ends of a product piece.

Separation of any fat or oil present in the filling from the other filling components can result in leaching into the outer shell, compromising its integrity and adversely impacting product quality. Leakage of the filling from the shell within the package will result in undesirable product pieces with hollow or semi hollow centers which are coated or stuck together with the escaped filling. As filled food products are an ideal format for portable use by consumers to eat “on the go” or while engaging in other activities, leakage of a filling renders the product undesirably messy and thus unsuitable for this purpose. Additionally, leakage can allow more rapid degradation of the filling as it is no longer protected by the outer shell as would be the case when the integrity of the product is maintained. Thus, it is also often ideal for a filling to set up to reach its final desired consistency within the outer shell prior to packaging to avoid leakage.

The invention is further defined by the following additional embodiments:
1. A process comprising
   providing a filling having a water content less than or equal to 20% by weight and an overall fat content, the filling comprising
      at least one flour; and
      at least one solid fat, the at least one solid fat comprising at least 20% by weight of the overall fat content of the filling;
   disposing the filling within a dough by forming coextrusion to produce a filled rope;
   cutting the filled rope to form at least one piece having at least one open end;
   crimping the at least one open end to form at least one substantially sealed piece; and
   cooking the at least one substantially sealed piece to generate at least one substantially sealed cooked piece.
2. The process of embodiment 1 wherein cutting the filled rope and crimping the at least one open end are accomplished simultaneously.
3. The process of embodiment 1 or embodiment 2 further comprising drying the at least one substantially sealed cooked piece to provide a ready to eat food product having a substantially sealed, cooked edible outer shell.
4. A process comprising
   substantially sealing a filling within a dough to form at least one substantially sealed piece, the filling having a water content less than or equal to 20% by weight and an overall fat content, the filling comprising
      at least one flour; and
      at least one solid fat, the at least one solid fat comprising at least about 20% by weight of the overall fat content of the filling; and cooking the at least one substantially sealed piece to generate at least one cooked piece.
5. The process of embodiment 4 wherein substantially sealing the filling within the dough comprises
   depositing the filling on the dough;
   wrapping the dough about the filling to form a filled rope;
   cutting the filled rope to form at least one piece having at least one open end; and
   crimping the at least one open end to form the at least one substantially sealed piece.
6. The process of embodiment 5 wherein cutting the filled rope and crimping the at least one open end are accomplished simultaneously.
7. The process of embodiment 4 wherein substantially sealing the filling within the dough comprises depositing the filling on the dough; and wrapping the dough about the filling to form the at least one substantially sealed piece.
8. The process of embodiment 4 wherein substantially sealing the filling within the dough comprises injecting the filling within the dough to form the at least one substantially sealed piece.
9. The process of any one of embodiments 4-8 further comprising drying the at least one substantially sealed cooked piece to provide a ready to eat food product having a substantially sealed, cooked edible outer shell.
10. The process of any one of embodiments 1-9, wherein the filling has a water content less than or equal to 16% by weight before cooking.
11. The process of any one of embodiments 1-9, wherein the filling has a water content less than or equal to 13% by weight before cooking.
12. The process of any one of embodiments 1-9, wherein the filling has a water content less than or equal to 10% by weight before cooking.
13. The process of any one of embodiments 1-9, wherein the filling has a water content less than or equal to 7.5% by weight before cooking.
14. The process of any one of embodiments 1-13, wherein the filling has a water content of at least 1% by weight before cooking.
15. The process of any one of embodiments 1-13, wherein the filling has a water content of at least 3% by weight before cooking.
16. The process of any one of embodiments 1-13, wherein the filling has a water content of at least 5% by weight before cooking.
17. The process of any one of embodiments 1-13, wherein the filling has a water content of at least 6% by weight before cooking.
18. The process of any one of embodiments 1-13, wherein the filling has a water content of at least 6.5% by weight before cooking.
19. The process of any one of embodiments 1-9, wherein the filling has a water content of between about 1.25% by weight and about 9% by weight before cooking.
20. The process of any one of embodiments 1-9, wherein the filling has a water content of between about 6.5% by weight and about 7.5% by weight before cooking.
21. The process of any one of embodiments 1-20, wherein the filling has a total fat content of at least about 30% by weight of the total fat and flour present in the filling.
22. The process of any one of embodiments 1-20, wherein the filling has a total fat content of at least about 40% by weight of the total fat and flour present in the filling.
23. The process of any one of embodiments 1-22, wherein the filling has a total fat content of less than about 70% by weight of the total fat and flour present in the filling.
24. The process of any one of embodiments 1-22, wherein the filling has a total fat content of less than about 60% by weight of the total fat and flour present in the filling.
25. The process of any one of embodiments 1-22, wherein the filling has a total fat content of less than about 50% by weight of the total fat and flour present in the filling.
26. The process of any one of embodiments 1-20, wherein the filling has a total fat content of about 30% to about 70% by weight of the total fat and flour present in the filling.
27. The process of any one of embodiments 1-20, wherein the filling has a total fat content of about 40% to about 60% by weight of the total fat and flour present in the filling.
28. The process of any one of embodiments 1-20, wherein the filling has a total fat content of about 40% to about 50% by weight of the total fat and flour present in the filling.
29. The process of any one of embodiments 1-28, wherein the at least one solid fat comprises at least about 25% by weight of the overall fat content of the filling.
30. The process of any one of embodiments 1-28, wherein the at least one solid fat comprises at least about 30% by weight of the overall fat content of the filling.
31. The process of any one of embodiments 1-28, wherein the at least one solid fat comprises at least about 40% by weight of the overall fat content of the filling.
32. The process of any one of embodiments 1-28, wherein the at least one solid fat comprises at least about 50% by weight of the overall fat content of the filling.
33. The process of any one of embodiments 1-28, wherein the at least one solid fat comprises at least about 60% by weight of the overall fat content of the filling.
34. The process of any one of embodiments 1-28, wherein the at least one solid fat comprises at least about 70% by weight of the overall fat content of the filling.
35. The process of any one of embodiments 1-28, wherein the at least one solid fat comprises at least about 80% by weight of the overall fat content of the filling.
36. The process of any one of embodiments 1-28, wherein the at least one solid fat comprises at least about 90% by weight of the overall fat content of the filling.
37. The process of any one of embodiments 1-28, wherein the at least one solid fat comprises at least about 95% by weight of the overall fat content of the filling.
38. The process of any one of embodiments 1-28, wherein the at least one solid fat comprises at least about 20% by weight of the overall fat content of the filling but less than about 80% by weight of the overall fat content of the filling.
39. The process of any one of embodiments 1-28, wherein the at least one solid fat comprises at least about 30% by weight of the overall fat content of the filling but less than about 70% by weight of the overall fat content of the filling.
40. The process of any one of embodiments 1-28, wherein the at least one solid fat comprises at least about 40% by weight of the overall fat content of the filling but less than about 70% by weight of the overall fat content of the filling.
41. The process of any one of embodiments 1-28, wherein the at least one solid fat comprises at least about 50% by weight of the overall fat content of the filling but less than about 70% by weight of the overall fat content of the filling.
42. The process of any one of embodiments 1-41 wherein the filling does not comprise peanut flour.
43. The process of any one of embodiments 1-42 wherein the filling does not comprise almond flour.
44. The process of any one of embodiments 1-43 wherein the at least one flour comprises at least one leguminous flour.
45. The process of any one of embodiments 1-43 wherein the at least one flour comprises at least one seed flour.
46. The process of any one of embodiments 1-43 wherein the at least one flour comprises at least one tree nut flour.
47. The process of any one of embodiments 1-43 wherein the at least one flour comprises at least one flour selected from the group consisting of chickpea flour, pea flour, oat flour, white lentil flour, amaranth flour, cashew flour, pumpkin seed flour, red lentil flour, sunflower seed flour, tapioca flour, amioca, and mixtures thereof.
48. The process of any one of embodiments 1-43 wherein the at least one flour comprises at least one flour selected from the group consisting of chickpea flour, pea flour, oat flour, white lentil flour, and mixtures thereof.
49. The process of any one of embodiments 1-43 wherein the at least one flour comprises chickpea flour.
50. The process of any one of embodiments 1-43 wherein the at least one flour comprises pea flour.
51. The process of any one of embodiments 1-43 wherein the at least one flour comprises oat flour.
52. The process of any one of embodiments 1-41 and embodiment 43 wherein the at least one flour comprises peanut flour.
53. The process of any one of embodiments 1-43 wherein the at least one flour comprises white lentil flour.
54. The process of any one of embodiments 1-42 wherein the at least one flour comprises almond flour.
55. The process of any one of embodiments 1-41 wherein the at least one flour comprises amaranth flour.
56. The process of any one of embodiments 1-43 wherein the at least one flour comprises cashew flour.
57. The process of any one of embodiments 1-43 wherein the at least one flour comprises pumpkin seed flour.
58. The process of any one of embodiments 1-43 wherein the at least one flour comprises red lentil flour.
59. The process of any one of embodiments 1-43 wherein the at least one flour comprises sunflower seed flour.
60. The process of any one of embodiments 1-43 wherein the at least one flour comprises tapioca flour.
61. The process of any one of embodiments 1-43 wherein the at least one flour comprises amioca.
62. The process of any one of embodiments 1-61 wherein the filling further comprises at least one secondary flour comprising at least one flour selected from the group consisting of brown rice flour, buckwheat flour, quinoa flour, white rice flour, and corn flour.
63. The process of any one of embodiments 1-62 wherein the at least one solid fat comprises at least one solid fat selected from the group consisting of palm oil, coconut oil, and cocoa butter.
64. The process of any one of embodiments 1-62 wherein the at least one solid fat comprises coconut oil.
65. The process of any one of embodiments 1-62 wherein the at least one solid fat comprises palm oil.
66. The process of any one of embodiments 1-62 wherein the at least one solid fat comprises cocoa butter.
67. The process of any one of embodiments 1-66, further comprising treating the at least one substantially sealed piece with a caustic before cooking.
68. The process of any one of embodiments 1-66, wherein the at least one substantially sealed piece is not treated with a caustic before cooking.
69. The process of any one of embodiments 1-68, wherein the cooking is carried out at a temperature of at least about 300° F.
70. The process of any one of embodiments 1-68, wherein the cooking is carried out at a temperature of at least about 375° F.
71. The process of any one of embodiments 1-68, wherein the cooking is carried out at a temperature of at least about 450° F.
72. The process of any one of embodiments 1-71, wherein the cooking is carried out at a temperature of less than about 600° F.
73. The process of any one of embodiments 1-71, wherein the cooking is carried out at a temperature of less than about 525° F.
74. The process of any one of embodiments 1-71, wherein the cooking is carried out at a temperature of less than about 450° F.
75. The process of any one of embodiments 1-71, wherein the cooking is carried out at a temperature of less than about 375° F.
76. The process of any one of embodiments 1-68, wherein the cooking is carried out at a temperature of from about 300° F. to 375° F.
77. The process of any one of embodiments 1-68, wherein the cooking is carried out at a temperature of from 376° F. to 450° F.
78. The process of any one of embodiments 1-68, wherein the cooking is carried out at a temperature of from 451° F. to about 525° F.
79. The process of any one of embodiments 1-78, wherein the cooking comprises baking.
80. The process of any one of embodiments 1-78, wherein the cooking comprises frying.
81. The process of any one of embodiment 3 or embodiments 9-80 wherein the ready to eat food product has a water content of less than or equal to about 3.5% by weight.
82. The process of any one of embodiment 3 or embodiments 9-80 wherein the ready to eat food product has a water content of less than or equal to about 3% by weight.
83. The process of any one of embodiment 3 or embodiments 9-80 wherein the ready to eat food product has a water content of less than or equal to about 2.5% by weight.
84. The process of any one of embodiment 3 or embodiments 9-83 wherein the ready to eat food product has a water content of greater than or equal to about 0.5% by weight.
85. The process of any one of embodiment 3 or embodiments 9-83 wherein the ready to eat food product has a water content of greater than or equal to about 1% by weight.
86. The process of any one of embodiment 3 or embodiments 9-83 wherein the ready to eat food product has a water content of greater than or equal to about 1.5% by weight.
87. The ready to eat food product having a substantially sealed, cooked edible outer shell prepared by the process of any one of embodiments 3 and 9-86.
88. The ready to eat food product of embodiment 87 wherein the outer shell is crunchy.
89. A ready to eat food product comprising
   a crunchy, substantially sealed, cooked edible outer shell; and
   a cooked filling cold formed within the outer shell, the filling comprising
      at least one solid fat; and
      at least one flour.
90. The ready to eat food product of embodiment 89 wherein the cooked filling does not comprise peanut flour or almond flour.
91. The food product of any one of embodiment 89 or embodiment 90 wherein the at least one solid fat comprises at least one fat selected from the group consisting of palm oil, coconut oil, cocoa butter, and mixtures thereof.
92. The food product of any one of embodiments 89-91 wherein the at least one flour comprises at least one leguminous flour.
93. The food product of any one of embodiments 89-91 wherein the at least one flour comprises at least one seed flour.
94. The food product of any one of embodiments 89-91 wherein the at least one flour comprises at least one tree nut flour.
95. The food product of any one of embodiments 89-91 wherein the at least one flour comprises tapioca flour.
96. The food product of any one of embodiments 89-91 wherein the at least one flour comprises amioca.
97. The food product of any one of embodiments 89-91 wherein the at least one flour comprises at least one flour selected from the group consisting of chickpea flour, pea flour, oat flour, peanut flour, white lentil flour, almond flour, amaranth flour, cashew flour, pumpkin seed flour, red lentil flour, sunflower seed flour, tapioca flour, amioca, and mixtures thereof.
98. The food product of any one of embodiments 89-91 wherein the at least one flour comprises chickpea flour.
99. The food product of any one of embodiments 89-91 wherein the at least one flour comprises pea flour.
100. The food product of any one of embodiments 89-91 wherein the at least one flour comprises oat flour.
101. The food product of any one of embodiments 89-91 wherein the at least one flour comprises peanut flour.
102. The food product of any one of embodiments 89-91 wherein the at least one flour comprises white lentil flour.
103. The food product of any one of embodiments 89-102 wherein the at least one solid fat comprises coconut oil.
104. The food product of any one of embodiments 89-103 wherein the filling further comprises at least one secondary flour selected from the group consisting of brown rice flour, buckwheat flour, quinoa flour, white rice flour, corn flour, and mixtures thereof.
105. The food product of any one of embodiments 89-104 wherein the filling has an overall fat content and the at least one solid fat comprises at least 20% by weight of the overall fat content of the filling.
106. The food product of any one of embodiments 89-104 wherein the filling has an overall fat content and the at least one solid fat comprises at least 30% by weight of the overall fat content of the filling.
107. The food product of any one of embodiments 89-104 wherein the filling has an overall fat content and the at least one solid fat comprises at least 40% by weight of the overall fat content of the filling.
108. The food product of any one of embodiments 89-104 wherein the filling has an overall fat content and the at least one solid fat comprises at least 50% by weight of the overall fat content of the filling.
109. The food product of any one of embodiments 89-104 wherein the filling has an overall fat content and the at least one solid fat comprises at least 60% by weight of the overall fat content of the filling.
110. The food product of any one of embodiments 89-104 wherein the filling has an overall fat content and the at least one solid fat comprises at least 70% by weight of the overall fat content of the filling.
111. The food product of any one of embodiments 89-104 wherein the filling has an overall fat content and the at least one solid fat comprises at least 80% by weight of the overall fat content of the filling.
112. The food product of any one of embodiments 89-104 wherein the filling has an overall fat content and the at least one solid fat comprises at least 90% by weight of the overall fat content of the filling.

### Ready to Eat Food Products

In some embodiments, the invention is drawn to a ready to eat food product comprising a crunchy, substantially sealed, cooked edible outer shell and a filling cold formed within said outer shell, said filling comprising at least one solid fat and at least one flour.

In a more specific embodiment, the at least one solid fat comprises at least one fat selected from the group consisting of palm oil, coconut oil, cocoa butter, and mixtures thereof.

In a more specific embodiment, the at least one solid fat comprises at least one fat selected from the group consisting of palm oil, coconut oil, cocoa butter, and mixtures thereof, and the at least one flour comprises at least one leguminous flour.

In another specific embodiment, the at least one solid fat comprises at least one fat selected from the group consisting of palm oil, coconut oil, cocoa butter, and mixtures thereof, and the at least one flour comprises at least one seed flour.

In another specific embodiment, the at least one solid fat comprises at least one fat selected from the group consisting of palm oil, coconut oil, cocoa butter, and mixtures thereof, and the at least one flour comprises at least one tree nut flour.

In another specific embodiment, the at least one solid fat comprises at least one fat selected from the group consisting of palm oil, coconut oil, cocoa butter, and mixtures thereof, and the at least one flour comprises oat flour.

In another specific embodiment, the at least one solid fat comprises at least one fat selected from the group consisting of palm oil, coconut oil, cocoa butter, and mixtures thereof, and the at least one flour comprises tapioca flour or amioca.

In another specific embodiment, the at least one solid fat comprises at least one fat selected from the group consisting of palm oil, coconut oil, cocoa butter, and mixtures thereof, and the at least one flour comprises at least one flour selected from the group consisting of chickpea flour, pea flour, oat flour, peanut flour, white lentil flour, almond flour, amaranth flour, cashew flour, pumpkin seed flour, red lentil flour, sunflower seed flour, tapioca flour, amioca, and mixtures thereof.

In another specific embodiment, the at least one solid fat comprises at least one fat selected from the group consisting of palm oil, coconut oil, cocoa butter, and mixtures thereof, and the at least one flour comprises chickpea flour.

In a more specific embodiment, the at least one solid fat comprises coconut oil and the at least one flour comprises chickpea flour.

In another specific embodiment, the at least one solid fat comprises at least one fat selected from the group consisting of palm oil, coconut oil, cocoa butter, and mixtures thereof, and the at least one flour comprises at least one flour selected from the group consisting of chickpea flour, pea flour, oat flour, peanut flour, white lentil flour, almond flour, amaranth flour, cashew flour, pumpkin seed flour, red lentil flour, sunflower seed flour, tapioca flour, amioca, and mixtures thereof, wherein the filling further comprises at least one secondary flour selected from the group consisting of brown rice flour, buckwheat flour, quinoa flour, white rice flour, corn flour, and mixtures thereof.

In another specific embodiment, the at least one solid fat comprises at least one fat selected from the group consisting of palm oil, coconut oil, cocoa butter, and mixtures thereof, and the at least one flour comprises chickpea flour, wherein the filling further comprises at least one secondary flour selected from the group consisting of brown rice flour, buckwheat flour, quinoa flour, white rice flour, corn flour, and mixtures thereof.

In another embodiment, the at least one solid fat comprises coconut oil, and the at least one flour comprises chickpea flour, wherein the filling further comprises at least one secondary flour selected from the group consisting of brown rice flour, buckwheat flour, quinoa flour, white rice flour, corn flour, and mixtures thereof.

In another embodiment, the at least one solid fat comprises coconut oil, and the at least one flour comprises at least one flour selected from the group consisting of chickpea flour, pea flour, oat flour, peanut flour, white lentil flour, almond flour, amaranth flour, cashew flour, pumpkin seed flour, red lentil flour, sunflower seed flour, tapioca flour, amioca, and mixtures thereof, wherein the filling further comprises at least one secondary flour selected from the group consisting of brown rice flour, buckwheat flour, quinoa flour, white rice flour, corn flour, and mixtures thereof.

In another embodiment, the invention is drawn to a ready to eat food product comprising a crunchy, substantially sealed, cooked edible outer shell and a filling cold formed within said outer shell, said filling comprising at least one solid fat and at least one flour, wherein the at least one flour comprises at least one flour selected from the group consisting of chickpea flour, pea flour, oat flour, peanut flour, white lentil flour, almond flour, amaranth flour, cashew flour, pumpkin seed flour, red lentil flour, sunflower seed flour, tapioca flour, amioca, and mixtures thereof.

In another embodiment, the invention is drawn to a ready to eat food product comprising a crunchy, substantially sealed, cooked edible outer shell and a filling cold formed within said outer shell, said filling comprising at least one solid fat and at least one flour, wherein the at least one solid fat comprises coconut oil and the at least one flour comprises at least one flour selected from the group consisting of chickpea flour, pea flour, oat flour, peanut flour, white lentil flour, almond flour, amaranth flour, cashew flour, pumpkin seed flour, red lentil flour, sunflower seed flour, tapioca flour, amioca, and mixtures thereof.

Processes for Manufacturing Ready to Eat Food Products Generally In some embodiments, the invention is drawn to a process for manufacturing a ready to eat food product having a substantially sealed, cooked edible outer shell, the process comprising providing a filling comprising at least one solid fat and at least one flour, the filling having a maximum water content of about 20% by weight; cold forming the filling within a dough to form a filled rope; cutting the filled rope to form at least one piece having at least one open end; crimping the at least one open end to at least substantially seal the dough of the at least one piece about the filling of the at least one piece; cooking the at least one piece; and drying the at least one piece to obtain the ready to eat food product.

In a more specific embodiment, cutting the filled rope and crimping the at least one open end are accomplished simultaneously.

### Processes for Manufacturing Ready to Eat Food Products Having a Pretzel Shell

In other specific embodiments, the general process for manufacturing the food product further comprises treating the at least one piece with a caustic before cooking the at least one piece.

In one such embodiment, the at least one flour comprises at least one flour selected from the group consisting of chickpea flour, pea flour, oat flour, peanut flour, white lentil flour, almond flour, amaranth flour, cashew flour, pumpkin seed flour, red lentil flour, sunflower seed flour, tapioca flour, amioca, and mixtures thereof.

In another such embodiment, the at least one flour comprises at least one flour selected from the group consisting of chickpea flour, pea flour, oat flour, peanut flour, white lentil flour, almond flour, amaranth flour, cashew flour, pumpkin seed flour, red lentil flour, sunflower seed flour, tapioca flour, amioca, and mixtures thereof, and the filling further comprises at least one secondary flour selected from the group consisting of brown rice flour, buckwheat flour, quinoa flour, white rice flour, corn flour, and mixtures thereof.

In another such embodiment, the at least one flour comprises chickpea flour.

In another such embodiment, the at least one flour comprises chickpea flour and the at least one solid fat comprises at least one fat selected from the group consisting of palm oil, coconut oil, cocoa butter, and mixtures thereof,

In another such embodiment, the at least one flour comprises chickpea flour and the at least one solid fat comprises coconut oil.

In another such embodiment, the at least one solid fat comprises at least one fat selected from the group consisting of palm oil, coconut oil, cocoa butter, and mixtures thereof,

In another such embodiment, the at least one solid fat comprises at least one fat selected from the group consisting of palm oil, coconut oil, cocoa butter, and mixtures thereof and the at least one flour comprises at least one flour selected from the group consisting of chickpea flour, pea flour, oat flour, peanut flour, white lentil flour, almond flour, amaranth flour, cashew flour, pumpkin seed flour, red lentil flour, sunflower seed flour, tapioca flour, amioca, and mixtures thereof.

In another such embodiment, the at least one solid fat comprises coconut oil and the at least one flour comprises at least one flour selected from the group consisting of chickpea flour, pea flour, oat flour, peanut flour, white lentil flour, almond flour, amaranth flour, cashew flour, pumpkin seed flour, red lentil flour, sunflower seed flour, tapioca flour, amioca, and mixtures thereof.

In another such embodiment, the at least one solid fat comprises coconut oil.

### Processes for Manufacturing Ready to Eat Food Products Having a Cracker, Cookie, or Other Non-Pretzel Shell

In other specific embodiments, where the product to be made does not have a pretzel shell, such as in the case of a cracker shell or a cookie shell, the general process for manufacturing the food product further requires cooking the at least one piece without having treated the at least one piece with a caustic.

In one such embodiment, the at least one flour comprises at least one flour selected from the group consisting of chickpea flour, pea flour, oat flour, peanut flour, white lentil flour, almond flour, amaranth flour, cashew flour, pumpkin seed flour, red lentil flour, sunflower seed flour, tapioca flour, amioca, and mixtures thereof.

In another such embodiment, the at least one flour comprises at least one flour selected from the group consisting of chickpea flour, pea flour, oat flour, peanut flour, white lentil flour, almond flour, amaranth flour, cashew flour, pumpkin seed flour, red lentil flour, sunflower seed flour, tapioca flour, amioca, and mixtures thereof, and the filling further comprises at least one secondary flour selected from the group consisting of brown rice flour, buckwheat flour, quinoa flour, white rice flour, corn flour, and mixtures thereof.

In another such embodiment, the at least one flour comprises chickpea flour.

In another such embodiment, the at least one flour comprises chickpea flour and the at least one solid fat comprises at least one fat selected from the group consisting of palm oil, coconut oil, cocoa butter, and mixtures thereof,

In another such embodiment, the at least one flour comprises chickpea flour and the at least one solid fat comprises coconut oil.

In another such embodiment, the at least one solid fat comprises at least one fat selected from the group consisting of palm oil, coconut oil, cocoa butter, and mixtures thereof,

In another such embodiment, the at least one solid fat comprises at least one fat selected from the group consisting of palm oil, coconut oil, cocoa butter, and mixtures thereof and the at least one flour comprises at least one flour selected from the group consisting of chickpea flour, pea flour, oat flour, peanut flour, white lentil flour, almond flour, amaranth flour, cashew flour, pumpkin seed flour, red lentil flour, sunflower seed flour, tapioca flour, amioca, and mixtures thereof.

In another such embodiment, the at least one solid fat comprises coconut oil and the at least one flour comprises at least one flour selected from the group consisting of chickpea flour, pea flour, oat flour, peanut flour, white lentil flour, almond flour, amaranth flour, cashew flour, pumpkin seed flour, red lentil flour, sunflower seed flour, tapioca flour, amioca, and mixtures thereof.

In another such embodiment, the at least one solid fat comprises coconut oil.

### Examples

The present invention is further illustrated by the following examples which are not intended to limit the effective scope of the claims. All parts and percentages in the examples and throughout the specification and claims are by weight of the final composition unless otherwise specified.

### Example 1

This example demonstrates the performance of several compositions with respect to suitability criteria for use as filling bases and fillings for use in forming coextrusion followed by baking. A composition of a plant-based fat mixed with plant flour according to one aspect of the present invention was assessed in comparison with a natural peanut butter-based control sample and a dairy based composition including ingredients currently used in topically applied and/or post baked dairy fillings and coatings. The proposed inventive composition was tested for suitability of its thermal stability and physical properties for use as a filling base in this experiment.

### Sample Selection and Preparation

Many baked coextruded products of the prior art rely upon peanut butter-based fillings as these compositions exhibit the requisite texture ideal for forming and filling the coextruded rope as well as the thermal stability to undergo the baking step. Peanut butter possesses the unique physical properties to allow the material to be pumped or conveyed into the process and yield product of acceptable quality regardless of product shape. Advantageously, peanuts and some other nuts such as almonds can be used with minor variations in parameters such as oil content largely as is depending on processing parameters such as temperature for conveying the sample into the coextrusion process. Thus, a natural vegan peanut butter consisting of ground peanuts and salt was used as a control to evaluate the samples in this experiment. Unlike both the traditional dairy based composition and the composition of fat and plant flour of the present invention, the peanut butter control contained neither palm oil nor soy lecithin. This peanut butter control exhibited minor oil separation and was thus subjected to mixing immediately prior to baking.

Dairy based compositions, including cheese toppings and fillings, enjoy broad consumer interest and represent a large market for food manufacturers. Unfortunately, traditional dairy ingredients cannot withstand the thermal requirements of coextrusion and baking and thus are typically used in fillings and toppings that are applied during a subsequent step post bake or in low temperature par baked processes which are unable to create products with a crunchy shell. To assess the performance of a dairy based filling to thermal treatment, a mixture was prepared according to the formula shown in Table 2.

TABLE 2
Traditional Dairy-Based Composition

| | |
|---|---|
| Sweet Whey Powder | 45.0 |
| Palm Oil (Non-hydrogenated, zero trans fat) | 44.5 |
| Cheddar Cheese Powder | 10.0 |
| Liquid Soy Lecithin | 0.5 |
| TOTAL | 100% |

The palm oil used was a non-hydrogenated, zero trans fat palm oil with a Mettler drop point of 103-110° F. and a solid fat content of 50-55% (10° C./50° F.), 28-33% (20° C./68° F.), 10-15% (30° C./86° F.), and 2-7% (40° C./104° F.). Soy lecithin was mixed into the melted palm oil, followed by the addition with stirring of the dry ingredients.

A 50% fat:50% plant flour composition was also prepared according to one embodiment of the present invention for use as a heat stable filling base for preparing various filled food products via coextrusion and baking. The formula for this filling base composition, which included the same palm oil and lecithin as in the dairy-based sample, is shown in Table 3.

TABLE 3
Proposed Filling Base Composition (50% fat:50% plant flour)

| | |
|---|---|
| Palm Oil (Non-hydrogenated, zero trans fat) | 49.80 |
| Chickpea (Garbanzo bean) Flour | 49.80 |
| Liquid Soy Lecithin | 0.40 |
| TOTAL | 100% |

Soy lecithin was mixed into the melted palm oil after which the chickpea flour was added with stirring. This and similar compositions could be useful filling bases which can be adapted in combination with one or more flavors, seasonings, herbs, spices, colors, or other ingredients to create baked extruded products for a variety of applications.

### Sample Evaluation

### Pre-Bake

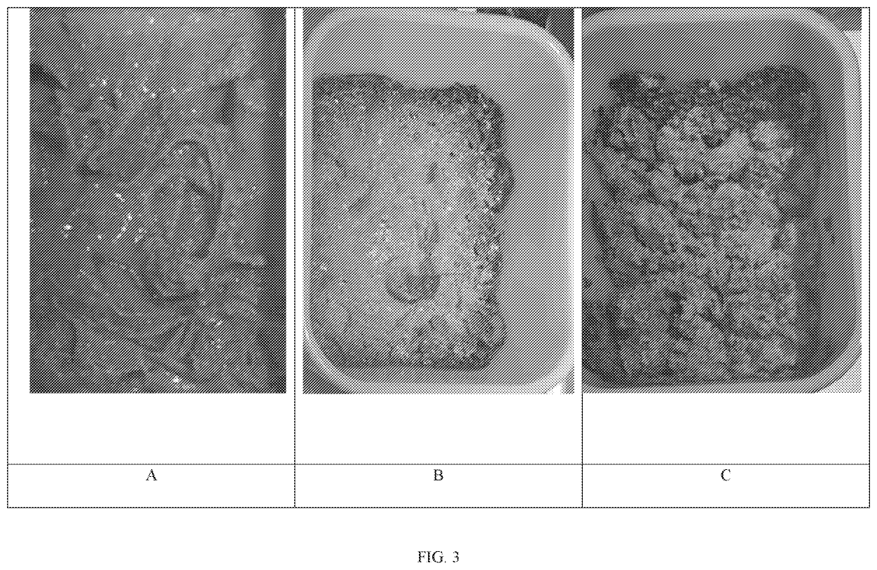

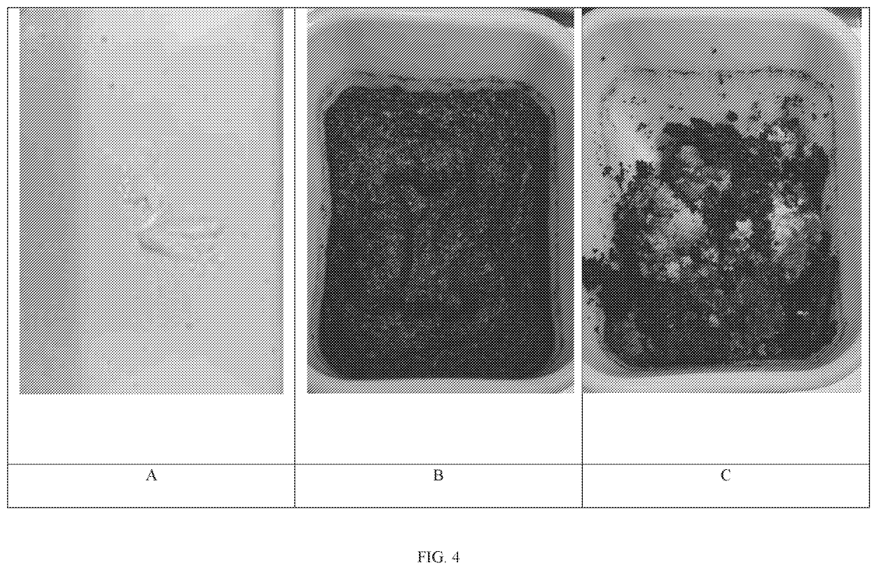

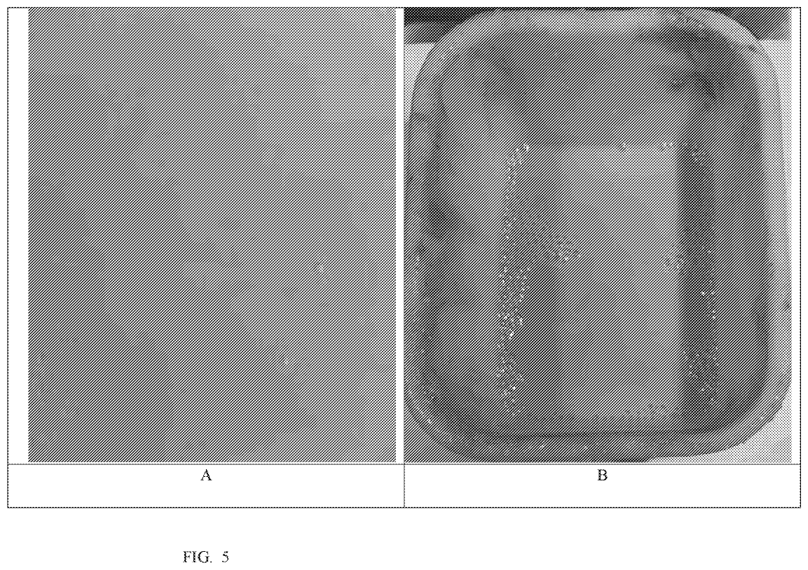

Samples of the natural peanut butter control, dairy-based sample and 50% fat:50% plant flour filling base are shown before baking in FIGS. 3A, 4A and 5A, respectively. The premixed natural peanut butter control exhibited minimal oil separation as seen in FIG. 3A. The viscosity of the control can be reduced by the application of moderate heat and the addition of oil as needed to ensure it can be pumped and extruded. Likewise, the dairy-based sample (FIG. 4A) and 50% fat:50% plant flour filling base sample (FIG. 5A) both mixed easily and exhibited minimal oil separation. Both samples could also undergo the application of moderate heat to reduce the viscosity sufficiently to enable pumping and extrusion.

### Baking

Each sample was baked at 500° F. for 15 minutes in a pyrex dish in a standard kitchen oven to model the thermal treatment during baking of the filling within the coextruded dough shell. Baked samples of the natural peanut butter control, dairy-based sample and 50% fat:50% plant flour filling base are shown in FIGS. 3B, 4B and 5B, respectively. Baked natural peanut butter control and traditional dairy based samples were also agitated to ascertain internal consistency and are shown in FIGS. 3C and 4C, respectively.

The baked peanut butter control exhibited some browning around the edges of the pyrex dish (FIG. 3B) but this is likely not an issue within the shell of a food product during coextrusion. As expected, the control did not burn (FIG. 3C). It is known from coextruded peanut butter filled pretzel products in the prior art that some oil from such fillings migrates into the pretzel shell. The degree of oil separation in this sample is thus expected to be acceptable.

Unlike the control, the baked dairy-based sample exhibited significant scorching and burning across the surface of the sample, even on areas not in contact with the pyrex dish (FIG. 4B). Evaluation of the stirred sample (FIG. 4C) indicated burning extended to parts of the inside of the dairy-based sample as well. Thus, the traditional dairy-based filling is expected to burn during baking within a coextruded product and is unsuitable for this purpose.

The 50% fat:50% plant flour filling base sample fared much better. As with the peanut butter control, mild browning was observed at the edges of the sample where it was in contact with the pyrex dish (FIG. 5B), which likewise is not expected to be an issue when the filling is baked in a coextruded shell. A moderate degree of bubbling was also observed during baking (FIG. 5B), although this is also not expected to be an issue when the filling is coextruded. Thus, the proposed composition according to the present invention appears to possess the requisite thermal stability to be used as a filling base for baking within a coextruded dough.

### Example 2

This example demonstrates the performance of a variety of compositions of a plant-based fat mixed with a plant flour according to one aspect of the present invention. The compositions differ in the relative amount of fat to flour to assess the range of compositions potentially suitable for use as filling bases to employ in baked coextruded products. These samples were subjected to the same thermal treatment (500° F. for 15 minutes in a standard kitchen oven) and evaluated on the same criteria as those described in the previous example to more fully ascertain the range of combinations which may provide acceptable filled food products according to the invention.

### Sample Preparation

Mixtures of the same palm oil and chickpea flour used in Example 1 were prepared in 7 different ratios according to the formulas provided in Table 4. Palm oil was melted and combined with stirring with the lecithin, followed by the addition of chickpea flour with stirring.

TABLE 4

| | Proposed Filling Base Compositions (% fat: % plant flour) | | | | | | |
|---|---|---|---|---|---|---|---|
| | 20:80 | 30:70 | 40:60 | 45:55 | 50:50 | 60:40 | 70:30 |
| Palm Oil | 19.88 | 29.88 | 39.84 | 44.82 | 49.80 | 59.76 | 69.72 |
| Chickpea Flour | 79.52 | 69.72 | 59.76 | 54.78 | 49.80 | 39.84 | 29.88 |
| Liquid Soy Lecithin | 0.60 | 0.40 | 0.40 | 0.40 | 0.40 | 0.40 | 0.40 |
| TOTAL | 100 | 100 | 100 | 100 | 100 | 100 | 100 |

Employing samples of progressively increasing flour content gives rise to pre-bake processability concerns, as the increased amount of dry ingredients adversely impacts proper mixing of the composition as well as the ability to pump or convey the filling into a coextruded rope. On the other hand, employing samples of progressively increasing fat content gives rise to concerns of bubbling or increased vaporization during cooking as well as concerns of oil separation from the filling after baking. The former could perforate the outer shell, while the latter could cause fat migration from the filling into the shell. Either of these could impact the integrity of the coextruded piece and negatively impact the quality of the resulting product. Thus, an optimum base filling recipe would balance the impact of these considerations to yield a product of the best quality. The balance may differ depending upon the particular application, for example, a smoother and creamier or chunkier and more solid center may be desirable in different products. This balance will also be impacted by the types and amounts of minor ingredients, for example, flavors, colors, spices, and other agents, which may be included to tailor a given product to the desired specifications. As noted above, it is also possible to employ one or more pinholes or slits in certain embodiments to direct and control venting of the piece during cooking and so avoid undesired leaking depending upon the particular filling formulation.

### Sample Evaluation

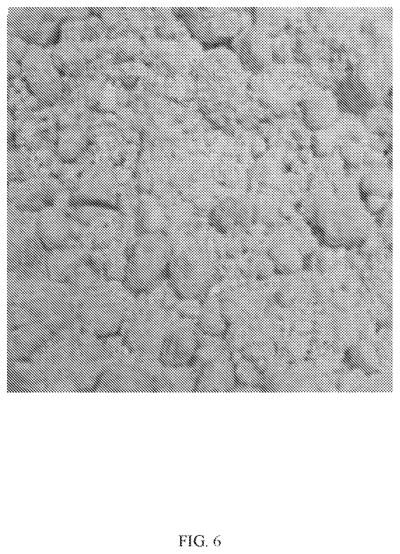

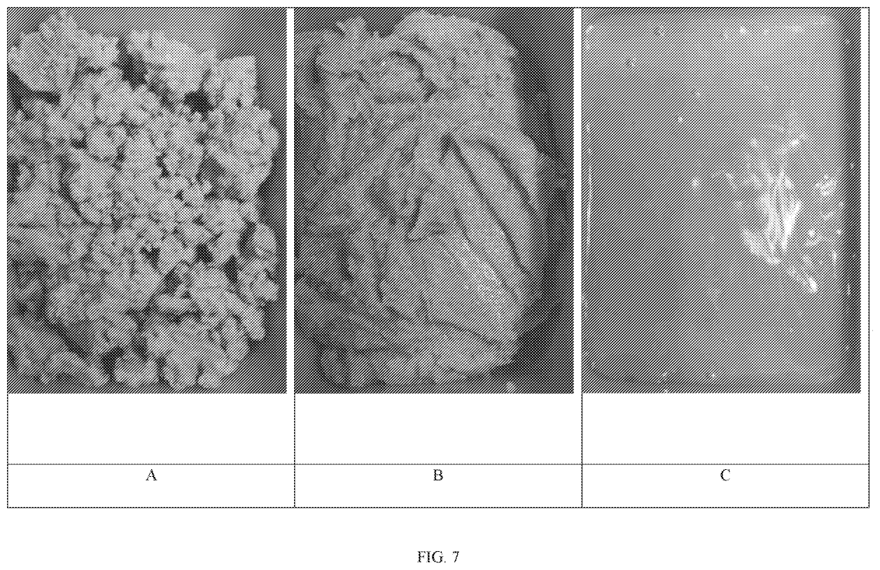

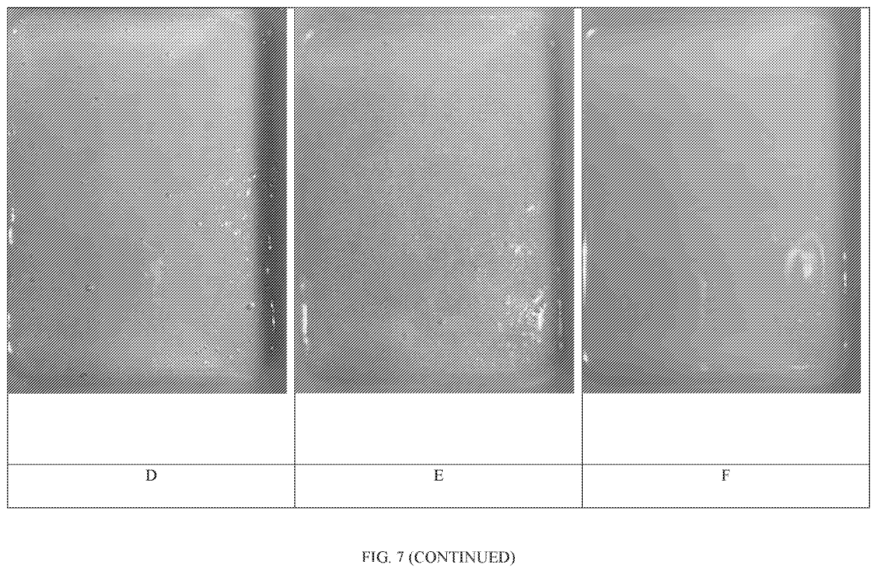

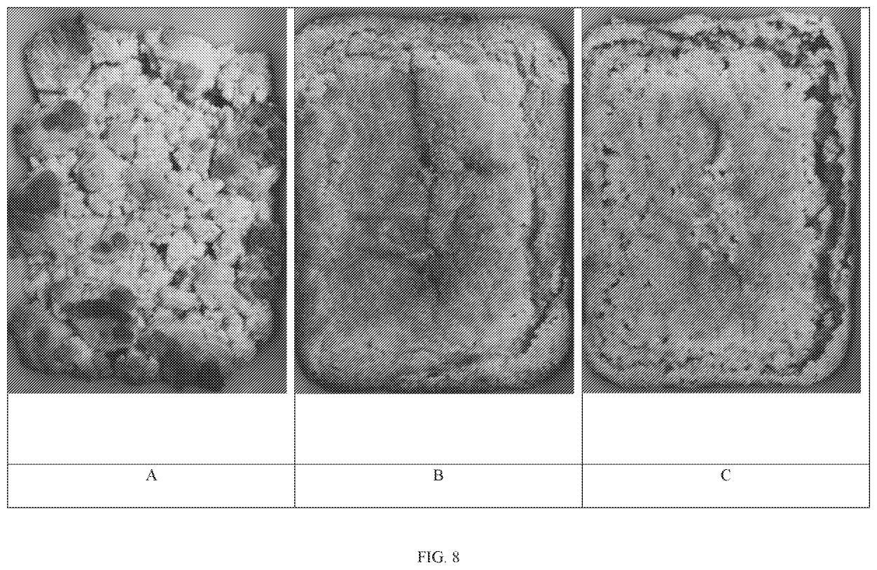

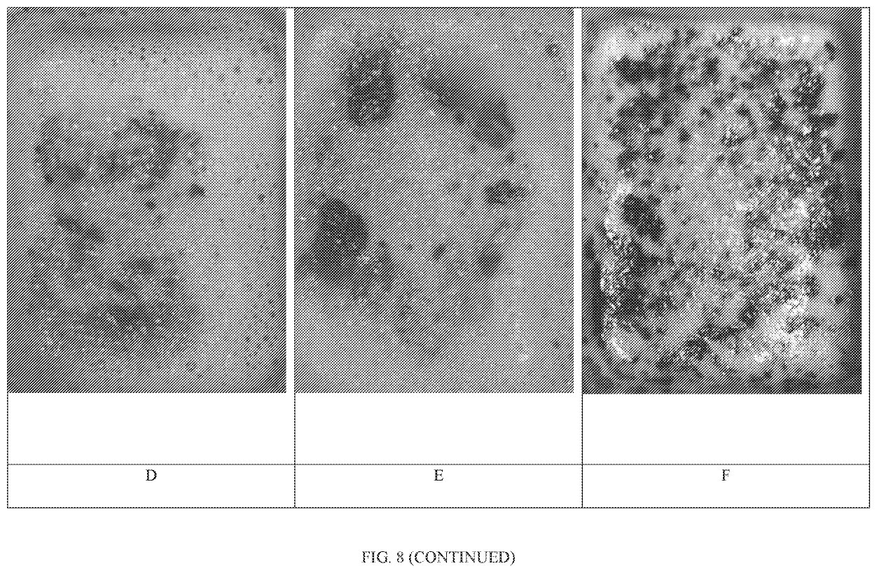

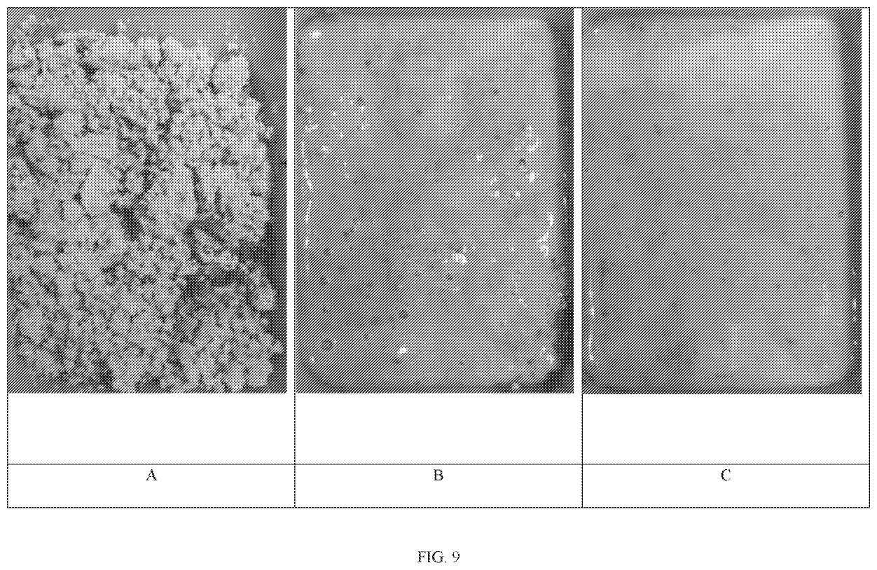

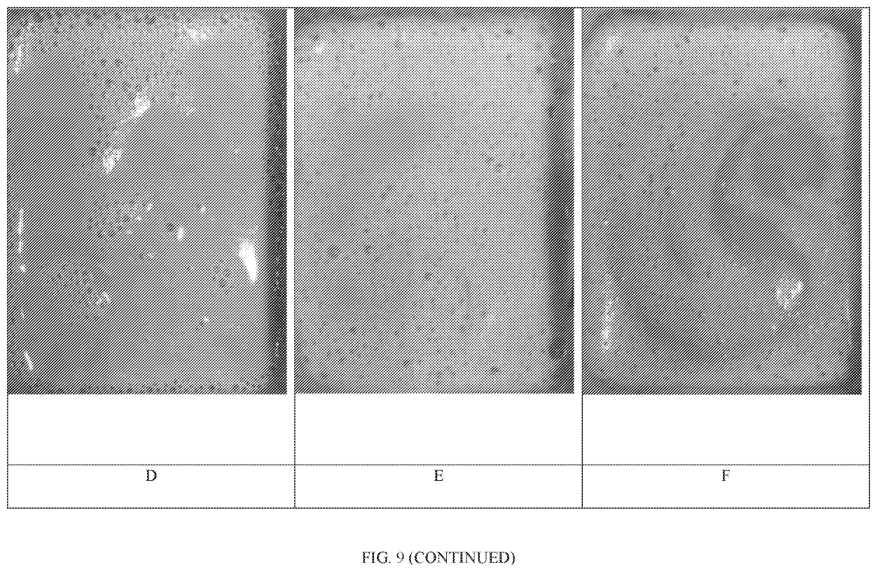

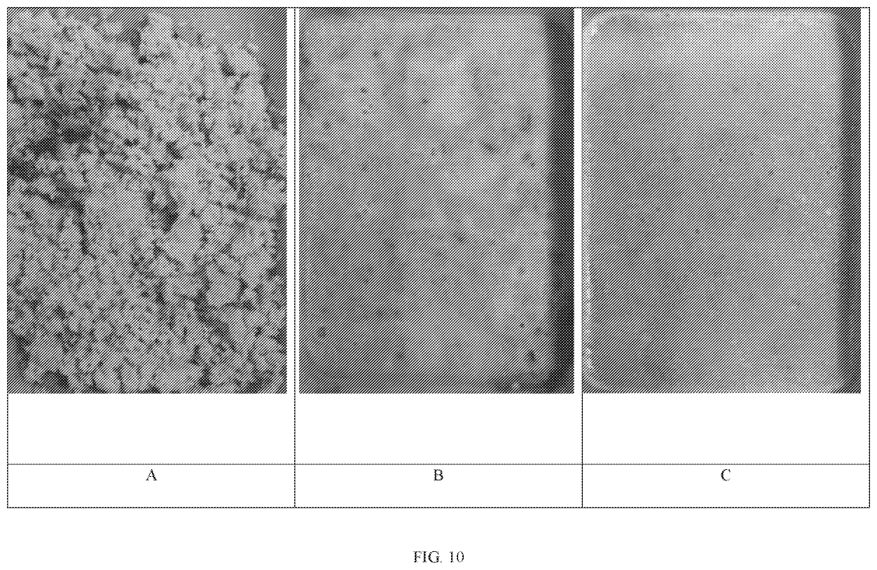

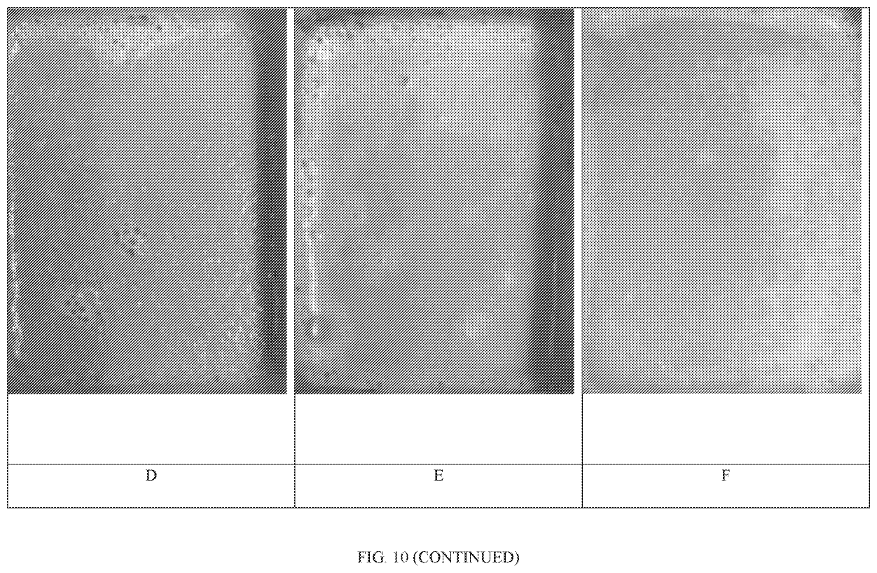

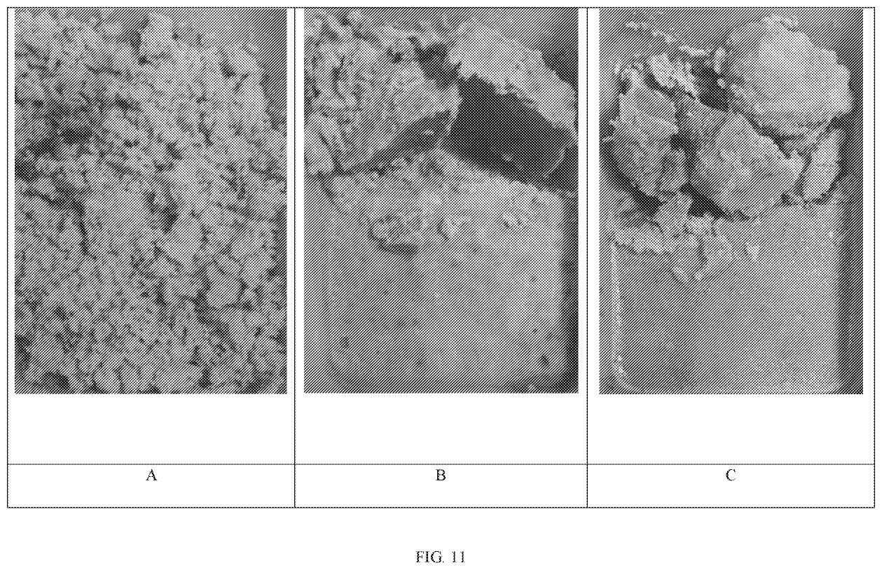

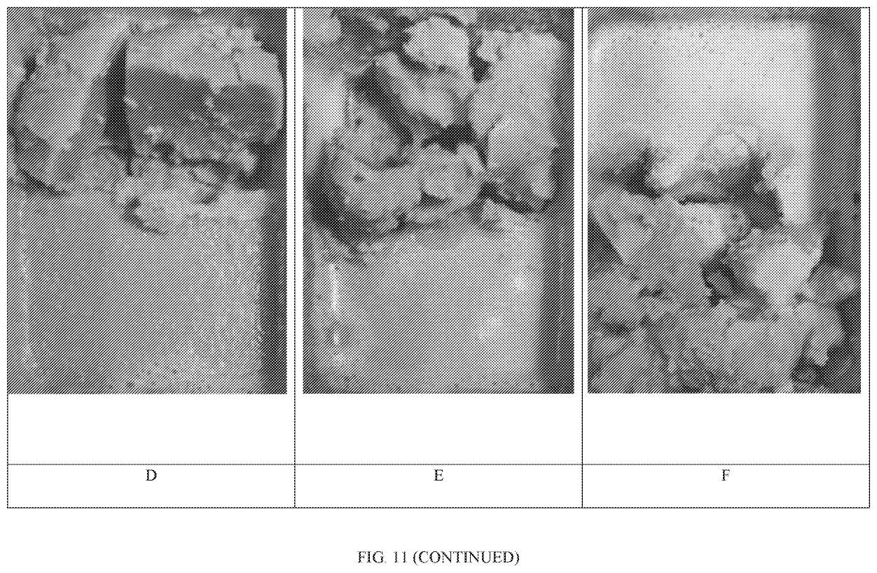

As an initial matter, the 20% fat:80% plant flour composition, pictured in FIG. 6, was far too dry and could not be appropriately mixed even with the addition of increased amounts of lecithin. Thus, this sample was not baked. The remaining samples were evaluated during and after baking. Pre-baked samples are shown in FIG. 7. Baked samples are shown as is in FIG. 8 and following stirring in FIG. 9. Following baking, samples were cooled to room temperature. The cooled samples are shown as is in FIG. 10 and following agitation to ascertain internal consistency in FIG. 11. In each of the foregoing figures, the panels correspond to the following samples: (A) 30% fat:70% plant flour; (B) 40% fat:60% plant flour; (C) 45% fat:55% plant flour; (D) 50% fat:50% plant flour; (E) 60% fat:40% plant flour; and (F) 70% fat:30% plant flour.

### Pre-Bake

Evaluation of the pre-baked samples is made with reference to FIG. 7. A repeat of the sample tested in Example 1, the 50% fat:50% plant flour filling base (FIG. 7D) mixed well and with the application of a moderate amount of heat can attain a viscosity enabling it to be pumped and conveyed into extruded ropes. Likewise, the 45% fat:55% plant flour filling base (FIG. 7C) mixed well and was only slightly more viscous. The 40% fat:60% plant flour filling base (FIG. 7B) mixed well but was significantly more viscous and will likely require more heat to pump and extrude. The 30% fat:70% plant flour filling base (FIG. 7A) required significantly more agitation to coat the plant flour with oil. The product was crumbly and may be difficult to pump even at elevated temperatures. Filling bases with decreased oil contents may be acceptable in applications where thicker fillings are desired; however, in particularly dry compositions appropriate means of conveying the sample would need to be used.

As the fat content was elevated above the original 50% fat:50% plant flour sample tested, the agitation required to mix the sample dropped; however, concerns of oil separation in the pre-baked sample rose. The 60% fat:40% plant flour filling base (FIG. 7E) mixed easily but slight oil separation was observed, likely because there was an insufficient amount of plant flour to absorb all of the oil present. This issue was more readily apparent in the 70% fat:30% plant flour filling base (FIG. 7F), which underwent phase separation prior to baking as evident from the glossy layer of oil atop the sample. Accordingly, filling bases with elevated oil contents may be acceptable in applications where other ingredients are included which can absorb the excess fat not able to be retained by the amount of plant flour included to avoid oil separation.

### Baking

Evaluation of the baked samples prior to cooling is made with reference to FIGS. 8 (undisturbed) and 9 (stirred immediately following baking). The criteria of interest in this step (see Table 1) are thermal stability and minimal to no leakage of the filling from the coextruded shell. The 50% fat:50% plant flour filling base (FIG. 8D) exhibited moderate foaming and slight browning. These phenomena progressively increased in the 60% fat and 70% fat samples (FIGS. 8E and 8F, respectively). Although some surface scorching was observed in the 70% fat sample, it exhibited neither the extent nor depth into the sample apparent in the traditional dairy-based sample of Example 1. Upon mixing each of the moderate to high fat samples appeared to be of acceptable quality (FIGS. 9D, 9E and 9F). Additionally, the foaming observed is thought to be an issue only in the model system which is unlikely to translate to problems when the filling is baked within a coextruded dough. Accordingly, the moderate to elevated fat samples tested appear to exhibit the thermal stability required for making baked filled food products.

As fat content decreased below the original 50% fat:50% plant flour sample tested, baked samples developed a surface crust which exhibited increased browning as the level of flour rose. Both the warm 45% fat (FIG. 8C) and 40% fat (FIG. 8B) samples retained a fluid texture beneath the crust evident upon stirring (FIGS. 9C and 9B, respectively). In neither case was the scorching evident in the traditional dairy-based sample observed. The baked 30% fat: 70% plant flour sample had a crumb texture with browning on the surface (FIG. 8A) which was observed to be diminished within individual pieces when the crumbs were stirred and broken (FIG. 9A). As with the foaming phenomena in the elevated fat samples, the surface crusting phenomena in the elevated flour samples is believed to be an issue only in this model system where the sample surface is exposed to air and is unlikely to arise when the filling is disposed within a coextruded dough during baking. This is in stark contrast to the scorching which penetrated the traditional dairy-based sample examined in Example 1. Accordingly, the moderate to elevated plant flour samples tested also appear to exhibit the thermal stability necessary to manufacture baked coextruded products.

### Post-Bake Cooling

Evaluation of the baked samples following cooling is made with reference to FIGS. 10 (undisturbed) and 11 (agitated to show internal consistency). Criteria include minimal to no oil phase separation following baking and the ability of the filling to set up to avoid leakage from the shell in a coextruded product. The 50% fat:50% plant flour filling base sample cooled to a solid slab which exhibited very slight oil separation evident as a minor sheen on the sample surface (FIG. 10D). The slab appeared homogeneous (FIG. 11D). A thin layer of separated fat appeared on the surface of the 60% fat sample (FIGS. 10E and 11E), which became significant in the 70% fat sample (FIGS. 10F and 11F). Such separation gives rise to concerns about fat migration into the outer shell of the finished product. Accordingly, filling bases incorporating higher levels of fat may be useful in applications where a more lubricious texture is desired, where minor ingredients are present which can complex the additional fat to keep it from separating out and migrating into and possibly compromising the outer shell, or where different consistencies of the outer shell per se, such as a softer or thicker shell, are desired.

Oil phase separation after baking reduced as flour content of the samples rose. The 45% fat sample exhibited even less separation than the 50% fat sample, as evidenced by the flatter surface tone in FIG. 10C relative to the glossier surface in FIG. 10D. The 40% fat sample showed no phase separation upon cooling (FIG. 10B). Both the 45% fat and 40% fat samples cooled to largely homogeneous slabs (FIGS. 11C and 11B, respectively). Oil phase separation was not an issue in the 30% fat sample which had a crumb consistency due to the excess flour (FIG. 10A). Accordingly, filling bases incorporating higher levels of plant flour maybe useful in applications where a firmer or drier consistency is desired.

### Example 3

This example demonstrates the utility of a variety of plant-based flours as ingredients in the filling bases according to embodiments of the present invention. Different flours can provide different organoleptic properties to fillings, thus enhancing the flexibility of the present invention to provide a variety of unique filled products targeted to distinct consumer preferences.

### Sample Preparation

Seventeen different plant-based flours were incorporated in 45% fat:55% plant flour filling bases which were subjected to 500° F. for 15 minutes in a standard kitchen oven. The plant-based flours evaluated herein are listed in Table 5, while the formula for each filling base is provided in Table 6.

TABLE 5
Plant-Based Flours

| | | |
|---|---|---|
| Almond Flour | Field Pea Flour | Red Lentil Flour |
| Amaranth Flour | Golden Corn Flour Masa Harina | Sunflower Seed Flour |
| Brown Rice Flour | Oat Flour | Tapioca Flour |
| Buckwheat Flour | Peanut Flour | White Lentil Flour |
| Cashew Flour | Pumpkin Seed Flour | White Rice Flour |
| Chickpea Flour | Quinoa Flour | |

TABLE 6
Filling Base Composition (45% fat:55% plant flour)

| | |
|---|---|
| Plant-Based Flour | 55.0 |
| Palm Oil (Non-hydrogenated, zero trans fat) | 44.5 |
| Liquid Soy Lecithin | 0.5 |
| TOTAL | 100% |

Palm oil was first melted and lecithin was then added with stirring. The plant-based flour was then added to the mix of lipid and emulsifier with stirring.

### Sample Evaluation

Filling bases prepared from each flour tested did not scorch under the test conditions and thus appear to be heat stable to the conditions for baking of coextruded products. They also provided unique texture and flavor profiles; however, some were superior to others regarding the issue of oil separation from the baked filling, which can be cause for concern about migration of oil from the filling into the shell of a coextruded product. Evaluation of the filling bases on this criterion are summarized in Table 7.

TABLE 7

| Oil Separation from the | |
|---|---|
| Baked Filling Base | Plant Based Flour |
| Slight | Chickpea Flour |
| (Surface film <1 mm) | Field Pea Flour |
| | Oat Flour |
| | Peanut Flour |
| | White Lentil Flour |
| Moderate | Almond Flour |
| (Surface film 1-3 mm) | Amaranth Flour |
| | Cashew Flour |
| | Pumpkin Seed Flour |
| | Red Lentil Flour |
| | Sunflower Seed Flour |
| | Tapioca Flour |
| Significant | Brown Rice Flour |
| (Surface film >3 mm) | Buckwheat Flour |
| | Golden Corn Flour Masa Harina |
| | Quinoa Flour |
| | White Rice Flour |

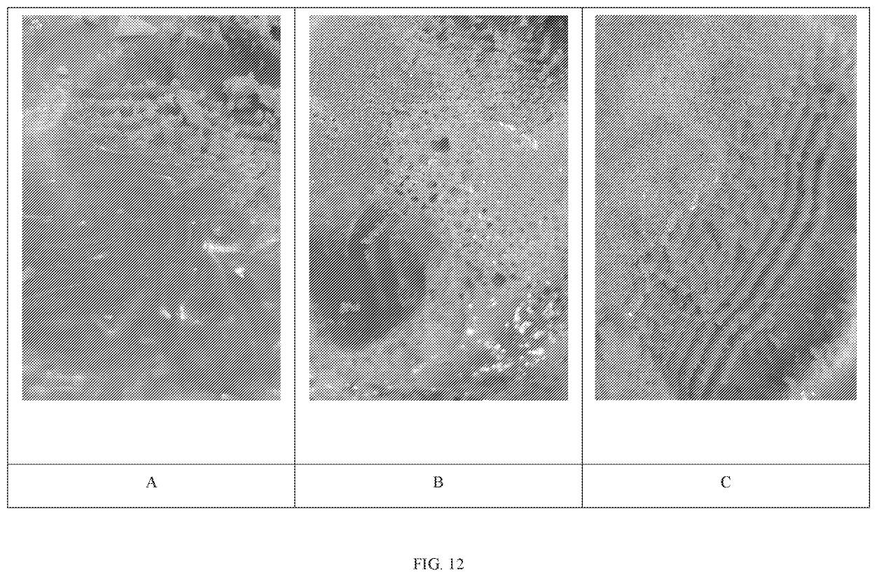

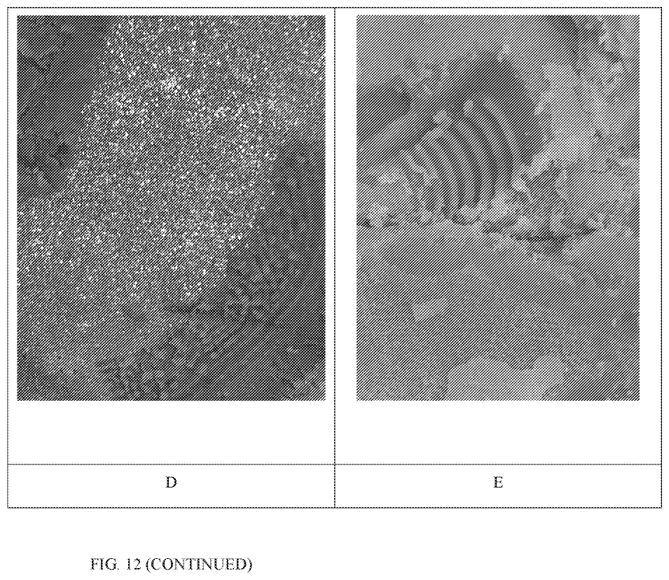

Filling bases made with different plant-based flours were categorized into three groups based on the thickness of the surface layer of oil on the baked and cooled sample. Samples made with five flours exhibited slight oil separation, wherein a surface film of less than 1 mm thickness was observed. These samples, shown in FIG. 12, include chickpea flour (FIG. 12A), field pea flour (FIG. 12B), oat flour (FIG. 12C), peanut flour (FIG. 12D) and white lentil flour (FIG. 12E). Among these samples, the sample prepared with chickpea flour appeared to have the least amount of oil separation. Interestingly, the sample prepared from oat flour also exhibited merely slight oil separation. This was the only grain flour tested which did not exhibit significant oil separation.

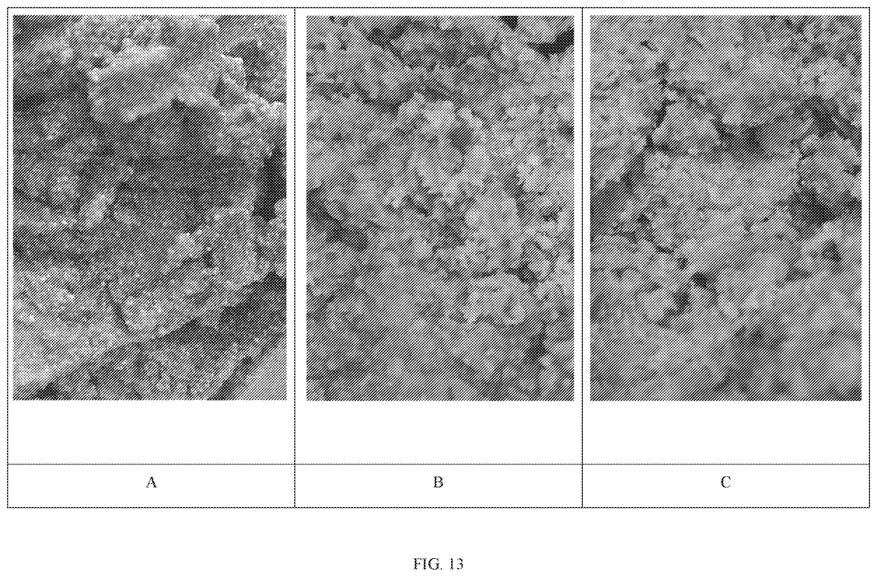

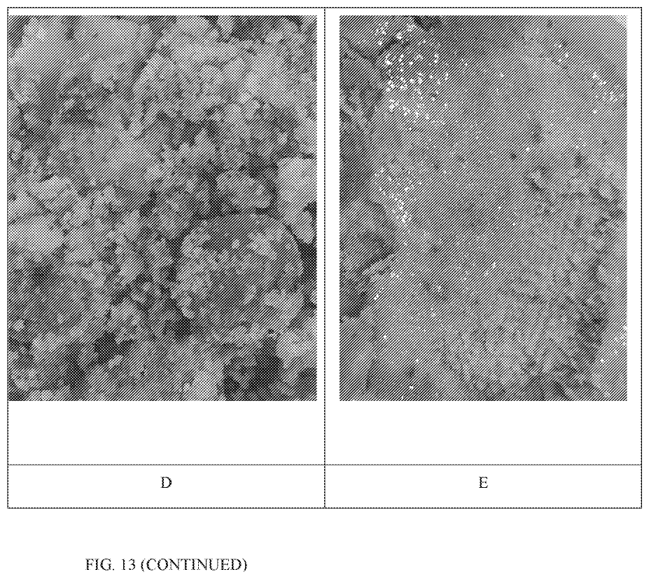

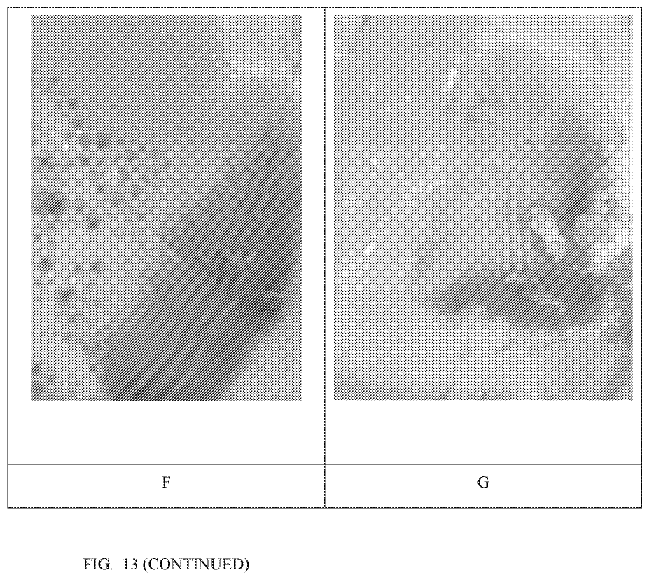

Seven more samples exhibited moderate oil separation, wherein a surface film of 1 mm to 3 mm thickness was observed. These samples, shown in FIG. 13, include the seed flours amaranth seed (FIG. 13A), pumpkin seed (FIG. 13B), and sunflower seed (FIG. 13C). The samples made using seed flours each had a clumpy texture. Also included in the moderate oil separation category were the tree nut flours almond (FIG. 13D) and cashew (FIG. 13E), and flours of the legume red lentil (FIG. 13F) and the spurge tapioca (FIG. 13G).

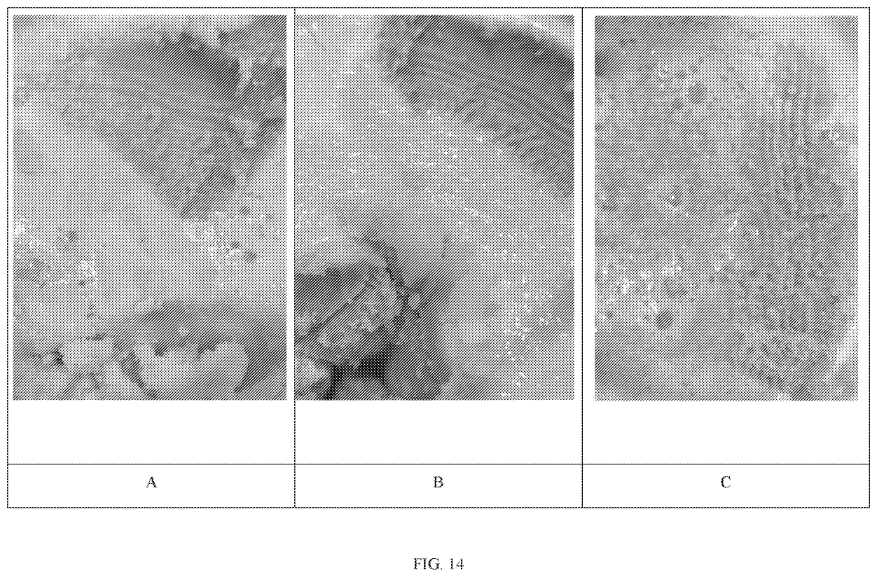

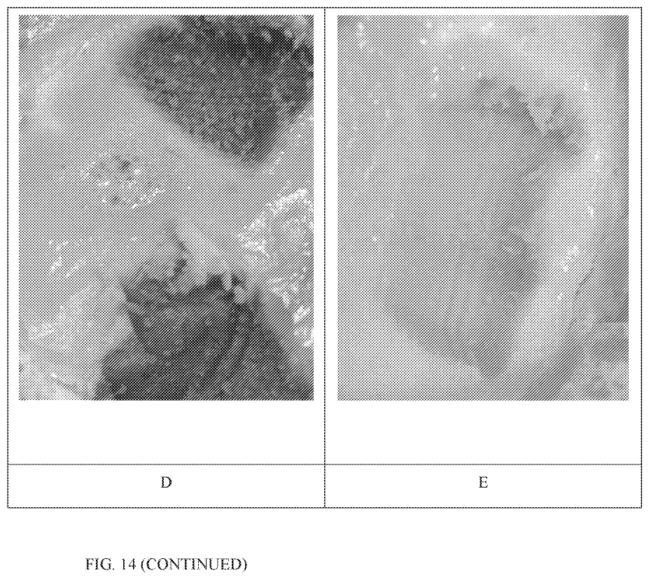

The last five samples exhibited significant oil separation, wherein a surface film over 3 mm thick was observed. These samples, shown in FIG. 14, include the grain flours brown rice (FIG. 14A), buckwheat (FIG. 14B), golden corn masa harina (FIG. 14C), quinoa (FIG. 14D), and white rice (FIG. 14E). Although these samples withstood the thermal treatment applied, it would be advantageous to improve their performance with respect to the degree of oil separation.

As expected from the results of Example 2, one avenue to incorporate any of the underperforming flours here in suitable fillings would be to alter the ratio of fat to flour content; however, another means to accomplish this could be to combine multiple plant flours to attenuate the degree of oil separation in the baked filling. Any flour with desirable organoleptic or nutritional properties that exhibits oil separation could be blended with a flour performing better on this measure. To evaluate this, filling base compositions according to the formula of Table 6 were prepared wherein the plant flour was one of the six blends with chickpea flour shown in Table 8. Comparative results of the oil separation observed in samples made using the pure flour and the corresponding sample prepared using the blend with chickpea flour are shown in Table 9.

TABLE 8
Plant Based Flour Blends:Chickpea with Secondary Flour

75% Chickpea Flour:25% Brown Rice Flour
75% Chickpea Flour:25% Golden Corn Flour Masa Harina
75% Chickpea Flour:25% Red Lentil Flour
75% Chickpea Flour:25% Sunflower Seed Flour
75% Chickpea Flour:25% Tapioca Flour
75% Chickpea Flour:25% White Lentil Flour

TABLE 9
Oil Separation from the Baked Filling Base

| 100% Plant | | Plant Based Flour |
|---|---|---|
| Based Flour | 75% Chickpea Flour:25% | Used as |
| (Original Sample) | Plant Based Flour Blend | Secondary Flour |
| Slight | Slight | White Lentil |
| Moderate | Slight | Red Lentil |
| Moderate | Slight | Sunflower Seed Flour |
| Moderate | Slight | Tapioca Flour |
| Significant | Slight | Brown Rice Flour |
| Significant | Slight | Golden Corn Flour |
| | | Masa Harina |

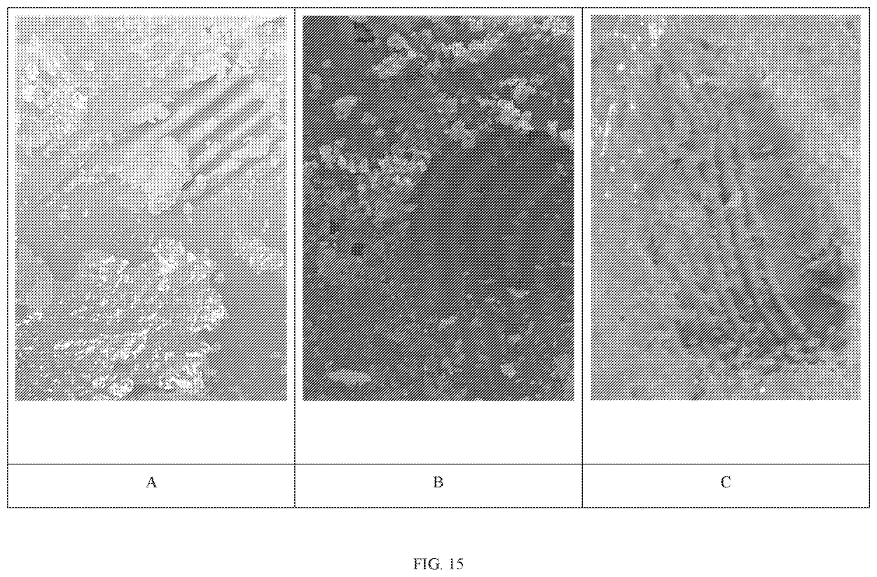

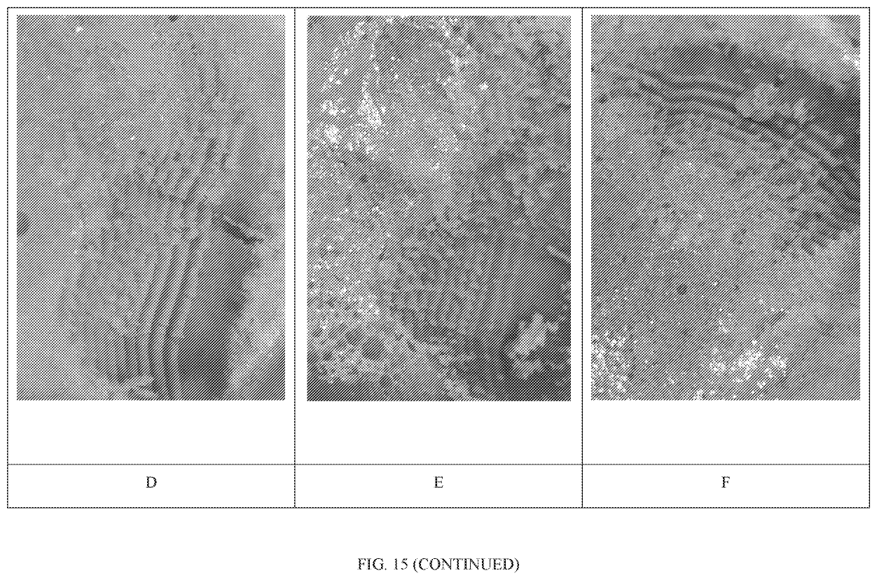

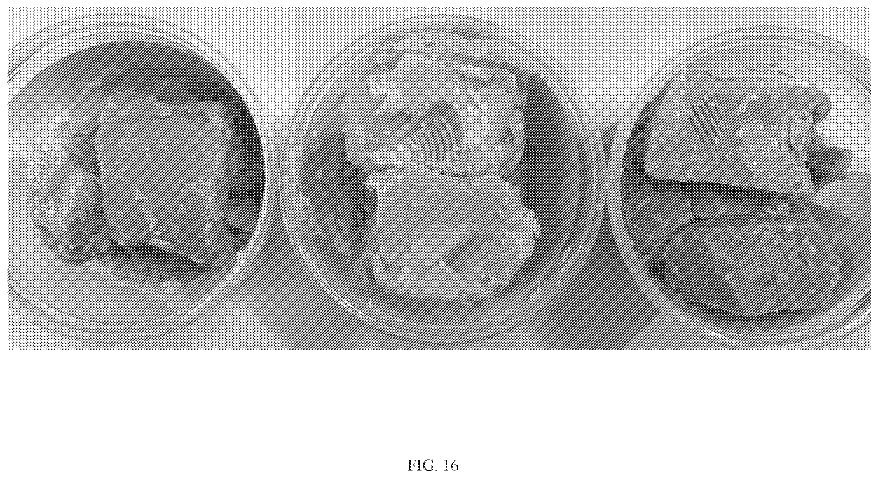

The use of a blend of flours appears to be a viable strategy to attenuate oil separation in baked fillings In each of the cases examined, blending the flour of interest as a secondary flour with three parts chickpea flour improved the quality of the baked filling and afforded the flexibility imparted by the secondary flour component to modulate the texture and flavor of the baked filling. Images of these blended flour samples are shown in FIG. 15 for combinations of chickpea flour with white lentil flour (FIG. 15A), red lentil flour (FIG. 15B), sunflower seed flour (FIG. 15C), tapioca flour (FIG. 15D), brown rice flour (FIG. 15E), and golden corn flour masa harina (FIG. 15F). Improvements were noted in comparison with the respective original samples made with white lentil flour (FIG. 12E), red lentil flour (FIG. 13F), sunflower seed flour (FIG. 13C), tapioca flour (FIG. 13G), brown rice flour (FIG. 14A), and golden corn flour masa harina (FIG. 14C).

Regardless of the enhanced degree of oil separation (moderate or significant) exhibited by the original flour, blending with 75% chickpea flour reduced oil separation in all samples tested to the slight category. Moreover, although the white lentil sample originally fell in the “slight” category, the film of separated oil was thicker than that seen in the original chickpea sample, and the blended sample showed improvement on the oil separation measure over the white lentil sample. This improvement is apparent from FIG. 16, showing a comparison of the samples made from pure chickpea flour (left), pure white lentil flour (center), and the 75:25 chickpea flour:white lentil flour blend (right).

Chickpea flour is also particularly noteworthy for use in the compositions of the present invention either as the sole flour or in flour blends as it has a clean flavor profile which requires little to no masking by any additional ingredients. The blends in Table 8 were successful in not only reducing the degree of oil separation, but also in imparting the organoleptic qualities of the minor flour to the sample. For instance, the blend containing corn flour exhibited a moderate toasted corn flavor. Thus, chickpea flour is advantageously versatile for preparing a wide variety of products with different flavor profiles according to the present invention.

Other flours exhibiting minimal oil separation could also be of utility either alone or in blends for more targeted products. Field pea flour has grassy notes and natural colors that could be useful in preparing food products targeted for vegetable flavors such as spinach dip or guacamole. Oat flour could be particularly useful in sweet products. Peanut flour could be useful in products where roasted and or sweet notes are desired. Such blends may utilize these flours as the main flour component with other secondary flours used to tailor flavor and texture profiles. These flours could also be used in blends with chickpea flour to further minimize oil separation.

Accordingly, plant-based flours can be used alone or in blends to prepare filling bases, fillings and filled products of the present invention. Advantageously, this enables the manipulation of flavor, texture, color, and other sensory attributes, as well as the degree of oil separation. The latter can be impacted not only by the affinity of any flour present for the oil but also by the particle size of such flour.

### Example 4

This example demonstrates the use of fillings of the present invention to produce filled, baked coextruded products according to another embodiment of the present invention. Three different savory filled pretzel products were made using three vegan filling formulations to produce a cheese flavored filled pretzel, a garlic and herb flavored filled pretzel, and a chipotle flavored filled pretzel. Each filling survived the thermal processing during actual baking within a coextruded pretzel dough to generate food products of acceptable quality and flavor without scorching or burning.

### Filling Preparation

### Baked Cheese Flavor

The formula for the baked cheese flavor filling is shown in Table 10.

TABLE 10
Baked Cheese Filling

| | |
|---|---|
| Chickpea (Garbanzo Bean) Flour | 52.26 |
| Palm Oil (Non-hydrogenated, zero trans fat) | 36.65 |
| Natural Flavors | 6.23 |
| Sea Salt | 2.30 |
| Ground Paprika | 2.07 |
| Liquid Soy Lecithin | 0.43 |
| Natural Color | 0.06 |
| TOTAL | 100.00% |

Palm oil was melted prior to the addition of lecithin with agitation. The blend of oil and emulsifier was transferred to a mixer and chickpea flour was then added as the blend was mixed to produce the filling base. The dry ingredients (flavors, sea salt and paprika) were then added as the filling base was mixed. Finally, natural color was added to the mixture with agitation. The melted filling was then transferred to a jacketed extruder hopper from which it was conveyed into the center of a coextruded rope.

### Garlic & Herb Flavor

The formula for the garlic & herb flavor filling is shown in Table 11.

TABLE 11
Garlic & Herb Filling

| | |
|---|---|
| Chickpea (Garbanzo Bean) Flour | 53.65 |
| Palm Oil (Non-hydrogenated, zero trans fat) | 37.77 |
| Herbs & Spices | 3.71 |
| Garlic Powder | 1.86 |
| Sea Salt | 1.04 |
| Onion Powder | 0.93 |
| Liquid Soy Lecithin | 0.58 |
| Natural Flavors | 0.46 |
| TOTAL | 100.00% |

Palm oil was melted prior to the addition of lecithin with agitation. The blend of oil and emulsifier was transferred to a mixer and chickpea flour was then added as the blend was mixed to produce the filling base. The dry ingredients (herbs & spices, garlic powder, sea salt and onion powder) were then added as the filling base was mixed. Finally, natural flavors were added to the mixture with agitation. The melted filling was then transferred to a jacketed extruder hopper from which it was conveyed into the center of a coextruded rope.

### Chipotle Flavor

The formula for the chipotle flavor filling is shown in Table 12.

TABLE 12
Chipotle Filling

| | |
|---|---|
| Chickpea (Garbanzo Bean) Flour | 51.34 |
| Palm Oil (Non-hydrogenated, zero trans fat) | 36.04 |
| Herbs & Spices | 4.71 |
| Brown Sugar | 4.25 |
| Sea Salt | 2.07 |
| Liquid Soy Lecithin | 0.57 |
| Natural Colors | 0.55 |
| Natural Flavors | 0.47 |
| TOTAL | 100.00% |

Palm oil was melted prior to the addition of lecithin with agitation. The blend of oil and emulsifier was transferred to a mixer and chickpea flour was then added as the blend was mixed to produce the filling base. The dry ingredients (herbs & spices, brown sugar, sea salt and flavors) were then added as the filling base was mixed. Finally, natural colors were added to the mixture with agitation. The melted filling was then transferred to a jacketed extruder hopper from which it was conveyed into the center of a coextruded rope.

### Coextrusion and Baking

Forming coextrusion and baking of the fillings in products having a pretzel shell was performed at the Reading Pretzel Company (Reading Bakery Systems, Reading, PA). Each filling was coextruded within a pretzel shell dough (67.4% pretzel flour, 29.7% water, 1.6% malt, and 1.3% oil with a dough temperature target of 105° F.) using a 6 mm inner diameter, 16 mm outer diameter coextrusion die at a head pressure between 60 to 80 psi. The coextruded rope was cut into sealed, filled pillows which proceeded to a caustic cooker having a temperature of 200° F. where the pillows were dipped in an aqueous solution of 0.75% to 1% sodium hydroxide. Pillows were then salted before proceeding into a 38-foot long multizone oven having two equal length zones. The oven temperature in the first zone was 565° F. while that in the second zone was 525° F. Pillows were conveyed at 7 feet per minute for a total residence time of 5 minutes and 26 seconds. Exit moisture of the product was within 10 to 12%. Baked pillows then passed through a 265° F. dryer for 25 minutes and 30 seconds to an exit moisture content target of 2-3%.

### Results

Each of the fillings tested withstood the thermal processing required to bake filled pretzel snack products of acceptable quality. The criteria recited in Table 1 were successfully addressed. Prior to bake the filling bases, which were approximately 41% fat:59% plant flour, were easily mixed with three different sets of ingredients and no separation of the oil phase was observed. Each filling formulation was able to be pumped into the center of a coextruded filled rope. During baking, the hot filling neither scorched within the center of the piece nor perforated the dough comprising the outer shell. Following baking, fillings cooled without leakage from the hardened shell. Oil phase separation from the baked filling and fat migration into the coextruded shell was not observed to be any more significant than that in commercially available peanut butter filled products of the prior art.

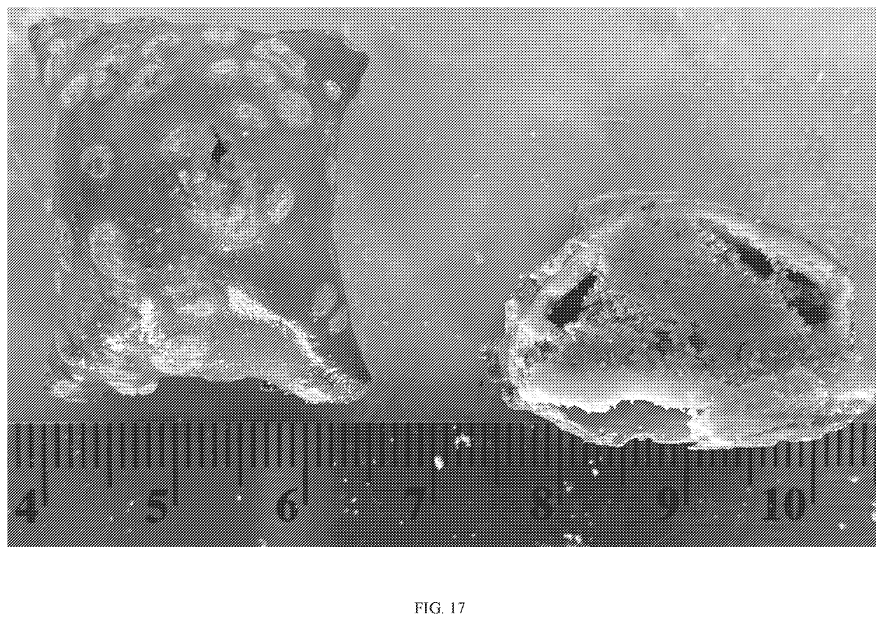

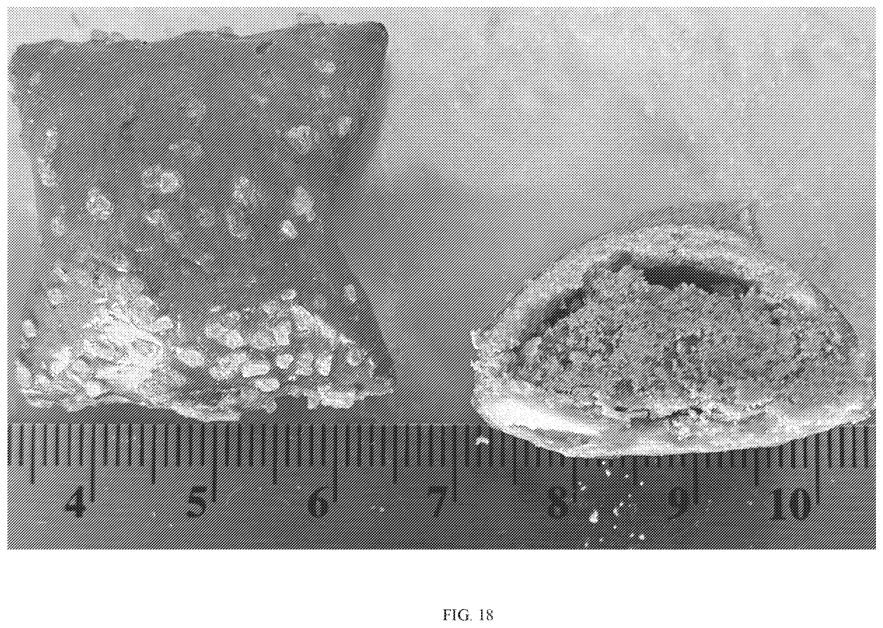

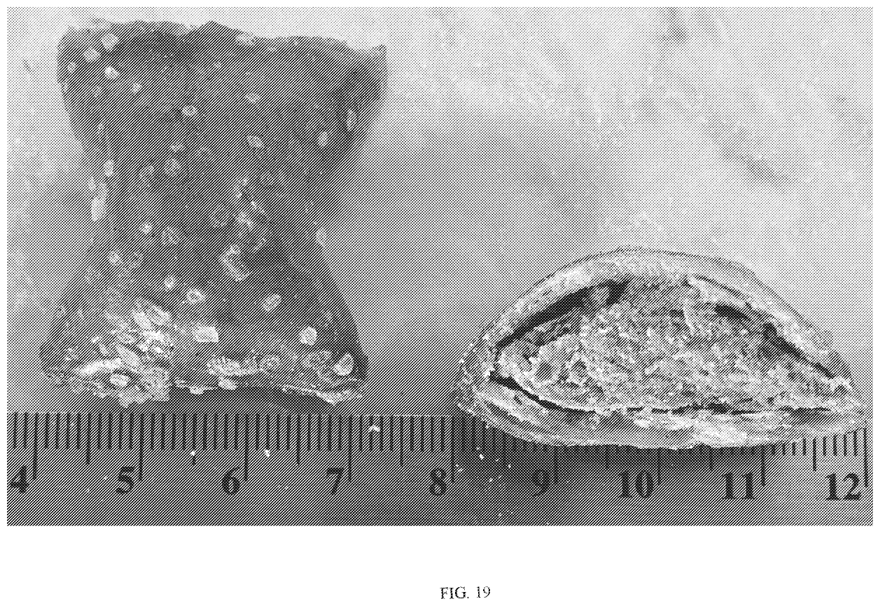

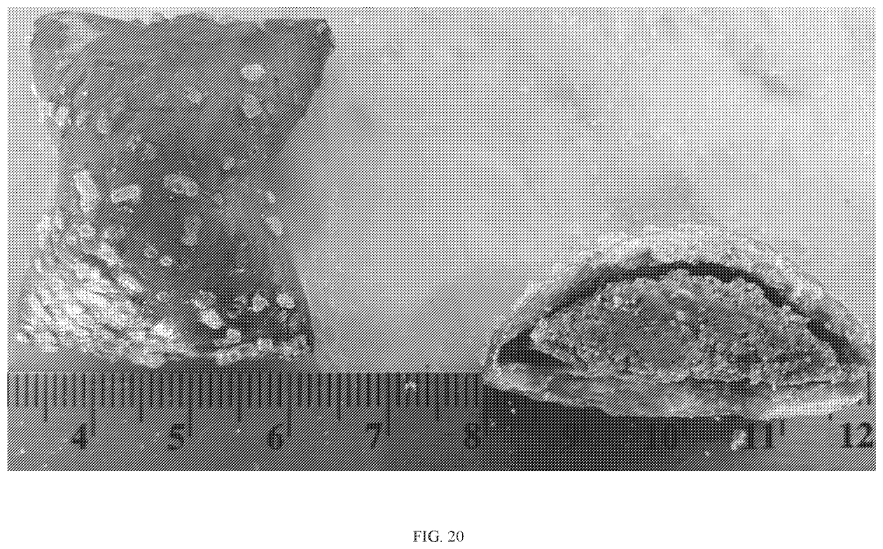

Each filled pretzel snack food product according to an embodiment of the invention was compared to a commercially available peanut butter filled pretzel of the prior art. The prior art product is shown in FIG. 17. The baked cheese, garlic and herb, and chipotle filled pretzel product embodiments of the proposed invention are shown in FIGS. 18, 19, and 20, respectively. Each image was taken with a centimeter ruler for scale and shows a sealed filled snack product pillow on the left and a cross-sectional cut of the product on the right.

None of the fillings of the present invention leaked during or after baking, as sealed pillows were obtained with the pretzel shells intact, and centers of each product contained a substantial amount of the filling, comparable to commercially available products of the prior art. The volume of filling in each piece was exceptional, indicating not only the suitability of chickpea flour and palm oil for good filling of the coextruded rope but also for the avoidance of leakage of the filling from the piece during and after baking. Additionally, referring to the cross-sectional product photos, the integrity of the coextruded shell in these embodiments was not adversely impacted by oil phase separation in any of the fillings tested. It is also noteworthy in the chipotle filled product that scorching was avoided despite the presence of brown sugar in the filling composition. Accordingly, filling bases of the present invention can be used successfully to create fillings with a variety of ingredients to enhance the flexibility of coextrusion to produce baked filled food products of the present invention with novel flavor and texture profiles for targeting different consumer preferences.

### Example 5

This example demonstrates the use of fillings of the present invention to produce filled, baked products having a sweet filling and either a cracker shell or a pretzel shell according to other embodiments of the present invention. Two chocolate flavor filled cracker products were made using coconut oil and either oat flour or chickpea flour in the respective fillings. Likewise, two chocolate flavor filled pretzel products were made using the respective fillings.

The formula for the oat flour chocolate flavor filling is shown in Table 13.

TABLE 13
Chocolate Filling with Oat Flour

| | |
|---|---|
| Oat Flour | 25.1 |
| Coconut Oil | 28.0 |
| Powdered Sugar | 21.0 |
| Cocoa Powder | 18.0 |
| Peanut Oil | 5.0 |
| Natural Flavors | 2.3 |
| Lecithin | 0.6 |
| TOTAL | 100.0% |

The formula for the chickpea flour chocolate flavor filling is shown in Table 14.

TABLE 14
Chocolate Filling with Chickpea Flour

| | |
|---|---|
| Chickpea (Garbanzo Bean) Flour | 25.0 |
| Coconut Oil | 28.0 |
| Powdered Sugar | 21.0 |
| Cocoa Powder | 18.0 |
| Peanut Oil | 5.0 |
| Natural Flavors | 2.3 |
| Lecithin | 0.7 |
| TOTAL | 100.0% |

Each filling was prepared by melting the coconut oil, combining with peanut oil, and adding lecithin with agitation. The blend of oil and emulsifier was transferred to a mixer and the respective flour (oat or chickpea) was added while mixing to produce the filling base. The dry ingredients (sugar and cocoa powder) were added to the filling base while mixing. Finally, natural flavors were added to the mixture with agitation to produce the respective filling.

A dough was made with 67.4% wheat flour, 29.7% water, 1.6% liquid malt, and 1.3% vegetable oil. To prepare the dough, liquid malt was pre-mixed with water, and the solution was added to wheat flour while mixing in a Hobart mixer. After the solution was fully added, the mass was mixed for 30 seconds, the oil was added, and the dough was mixed for 4 minutes at low speed. The dough was allowed to sit for 40 minutes prior to use.

Each filling was cold formed within the dough. This was accomplished on a lab scale by depositing a bead of filling on a 4.5 cm wide and 2 mm thick ribbon of dough which was then wrapped around the filling to create a filled tube representative of the filled ropes resulting from production scale forming coextrusion. The filled tube was cut and crimped manually using a steel commercial cutter element that is identical to the cutter used in commercial scale production to cut and crimp simultaneously.

For products having a cracker shell, the sealed pillow pieces were sprayed with warm water and salted prior to baking. For products having a pretzel shell, the sealed pillow pieces were dipped in a caustic solution for 20 seconds.

Pieces were baked on industrial baking pans fitted with wire baking racks in a batch convection oven set to an oven temperature of 475° F. for 8 minutes to reach an estimated moisture content of 10-12%. Pans were then immediately transferred to another batch convection oven set at 265° F. where pieces were dried for 25 minutes to an estimated final moisture content of 2-3%. These lab scale treatments were designed to emulate conditions of production scale cooking and drying, respectively.

The oat flour filling performed comparably to the chickpea flour formula with respect to thermal stability and neither scorched nor burned during baking and drying. However, a difference was observed respecting the rupture of crimped ends of the sealed pieces. Both pretzel and cracker products made using the chickpea formula filling did not display failure of the crimped seals, whereas those incorporating the oat flour formula filling, which was otherwise identical except for the flour type, underwent expansion resulting in the rupture of crimped ends in a number of the pieces. Accordingly, chickpea flour displayed inherently better properties relative to oat flour respecting thermal expansion during cooking and drying. Nevertheless, when products incorporating the oat flour formula filling were remade with venting by slitting or perforating the pieces prior to cooking, rupture of the crimped ends of the enclosed pieces no longer occurred. Thus, the products and methods of the present invention encompass sweet as well as savory options. The use and combination of different flours and solid fats, together with any procedures necessary or beneficial to eliminate any issues regarding structural integrity of the product during cooking and drying, affords great versatility in product formulation according to the present invention.

### Example 6

This example demonstrates the use of fillings of the present invention to produce filled, baked products having a savory filling and either a cracker shell or a pretzel shell according to other embodiments of the present invention. Two cheese flavor filled cracker products were made using coconut oil and either oat flour or chickpea flour in the respective fillings. Likewise, two cheese flavor filled pretzel products were made using the respective fillings.

The formula for the oat flour cheese flavor filling is shown in Table 15.

TABLE 15
Cheese Filling with Oat Flour

| | |
|---|---|
| Oat Flour | 52.9 |
| Coconut Oil | 30.0 |
| Peanut Oil | 7.0 |
| Flavors and Seasoning Blend | 9.5 |
| Lecithin | 0.6 |
| TOTAL | 100.0% |

The formula for the chickpea flour cheese flavor filling is shown in Table 16.

TABLE 16
Cheese Filling with Chickpea Flour

| | |
|---|---|
| Chickpea (Garbanzo Bean) Flour | 52.9 |
| Coconut Oil | 30.0 |
| Peanut Oil | 7.0 |
| Flavors and Seasoning Blend | 9.5 |
| Lecithin | 0.6 |
| TOTAL | 100.0% |

Each filling was prepared by melting the coconut oil, combining with peanut oil, and adding lecithin with agitation. The blend of oil and emulsifier was transferred to a mixer and the respective flour (oat or chickpea) was added while mixing to produce the filling base. Finally, the flavors and seasonings were added to the filling base while mixing.

A dough was made with 67.4% wheat flour, 29.7% water, 1.6% liquid malt, and 1.3% vegetable oil. To prepare the dough, liquid malt was pre-mixed with water, and the solution was added to wheat flour while mixing in a Hobart mixer. After the solution was fully added, the mass was mixed for 30 seconds, the oil was added, and the dough was mixed for 4 minutes at low speed. The dough was allowed to sit for 40 minutes prior to use.

Each filling was cold formed within the dough. This was accomplished on a lab scale by depositing a bead of filling on a 4.5 cm wide and 2 mm thick ribbon of dough which was then wrapped around the filling to create a filled tube representative of the filled ropes resulting from production scale forming coextrusion. The filled tube was cut and crimped manually using a steel commercial cutter element that is identical to the cutter used in commercial scale production to cut and crimp simultaneously.

For products having a cracker shell, the sealed pillow pieces were sprayed with warm water and salted prior to baking. For products having a pretzel shell, the sealed pillow pieces were dipped in a caustic solution for 20 seconds.

Pieces were baked on industrial baking pans fitted with wire baking racks in a batch convection oven set to an oven temperature of 475° F. for 8 minutes to reach an estimated moisture content of 10-12%. Pans were then immediately transferred to another batch convection oven set at 265° F. where pieces were dried for 25 minutes to an estimated final moisture content of 2-3%. These lab scale treatments were designed to emulate conditions of production scale cooking and drying, respectively.

As was the case with the sweet fillings of Example 5, the savory oat flour filling performed comparably to the savory chickpea flour formula with respect to thermal stability and neither scorched nor burned during baking and drying. Again, a difference was observed respecting the rupture of crimped ends of the sealed pieces. Both pretzel and cracker products made using the chickpea formula filling did not display failure of the crimped seals, whereas those incorporating the oat flour formula filling, which was otherwise identical except for the flour type, underwent expansion resulting in the rupture of crimped ends in a number of the pieces. Accordingly, the difference among chickpea flour and oat flour samples respecting thermal expansion was observed again in a different set of filling formulations.

Once again, when products incorporating the oat flour formula filling were remade with venting by slitting or perforating the pieces prior to cooking, rupture of the crimped ends of the enclosed pieces no longer occurred. Thus, the products and methods of the present invention encompass sweet as well as savory options. The use and combination of different flours and solid fats, together with any procedures necessary or beneficial to eliminate any issues regarding structural integrity of the product during cooking and drying, affords great versatility in product formulation according to the present invention.

What is claimed is:

1. A process comprising
providing a filling having a water content less than or equal to 20% by weight and an overall fat content, the filling comprising
at least one flour; and
at least one solid fat, the at least one solid fat comprising at least 20% by weight of the overall fat content of the filling;
disposing the filling within a dough by forming coextrusion to produce a filled rope;
cutting the filled rope to form at least one piece having at least one open end;
crimping the at least one open end to form at least one substantially sealed piece; and
cooking the at least one substantially sealed piece to generate at least one substantially sealed cooked piece.

2. The process of claim 1 further comprising drying the at least one substantially sealed cooked piece to provide a ready to eat food product having a substantially sealed, cooked edible outer shell.

3. The process of claim 1 wherein cutting the filled rope and crimping the at least one open end are accomplished simultaneously.

4. The process of claim 3 further comprising drying the at least one substantially sealed cooked piece to provide a ready to eat food product having a substantially sealed, cooked edible outer shell.

5. The process of claim 2 wherein the at least one flour comprises at least one leguminous flour.

6. The process of claim 2 wherein the at least one flour comprises at least one flour selected from the group consisting of chickpea flour, pea flour, oat flour, peanut flour, white lentil flour, almond flour, amaranth flour, cashew flour, pumpkin seed flour, red lentil flour, sunflower seed flour, tapioca flour, amioca, and mixtures thereof.

7. The process of claim 6 wherein the filling further comprises at least one secondary flour selected from the group consisting of brown rice flour, buckwheat flour, quinoa flour, white rice flour, corn flour, and mixtures thereof.

8. The process of claim 6 wherein the at least one flour comprises chickpea flour.

9. The process of claim 8 wherein the at least one solid fat comprises at least one fat selected from the group consisting of palm oil, coconut oil, cocoa butter, and mixtures thereof.

10. The process of claim 9 wherein the at least one solid fat comprises coconut oil.

11. The process of claim 6 wherein the at least one flour comprises oat flour.

12. The process of claim 11 wherein the at least one solid fat comprises at least one fat selected from the group consisting of palm oil, coconut oil, cocoa butter, and mixtures thereof.

13. The process of claim 12 wherein the at least one solid fat comprises coconut oil.

14. The process of claim 6 wherein the at least one flour comprises pea flour.

15. The process of claim 14 wherein the at least one solid fat comprises at least one fat selected from the group consisting of palm oil, coconut oil, cocoa butter, and mixtures thereof.

16. The process of claim 15 wherein the at least one solid fat comprises coconut oil.

17. The process of claim 6 wherein the at least one flour comprises white lentil flour.

18. The process of claim 17 wherein the at least one solid fat comprises at least one fat selected from the group consisting of palm oil, coconut oil, cocoa butter, and mixtures thereof.

19. The process of claim 18 wherein the at least one solid fat comprises coconut oil.

20. The process of claim 2 wherein the at least one solid fat comprises at least one fat selected from the group consisting of palm oil, coconut oil, cocoa butter, and mixtures thereof.

21. The process of claim 20 wherein the at least one flour comprises at least one flour selected from the group consisting of chickpea flour, pea flour, oat flour, peanut flour, white lentil flour, almond flour, amaranth flour, cashew flour, pumpkin seed flour, red lentil flour, sunflower seed flour, tapioca flour, amioca, and mixtures thereof.

22. The process of claim 21 wherein the at least one solid fat comprises coconut oil.

23. The process of claim 20 wherein the at least one solid fat comprises coconut oil.

24. A ready to eat food product having a substantially sealed, cooked edible outer shell prepared according to the process of any of claims 5-23.

25. A ready to eat food product comprising
a crunchy, substantially sealed, cooked edible outer shell; and
a filling cold formed within said outer shell, said filling comprising
at least one solid fat; and
at least one flour.

26. The food product of claim 25 wherein the at least one solid fat comprises at least one fat selected from the group consisting of palm oil, coconut oil, cocoa butter, and mixtures thereof.

27. The food product of claim 26 wherein the at least one flour comprises at least one leguminous flour.

28. The food product of claim 26 wherein the at least one flour comprises at least one flour selected from the group consisting of chickpea flour, pea flour, oat flour, peanut flour, white lentil flour, almond flour, amaranth flour, cashew flour, pumpkin seed flour, red lentil flour, sunflower seed flour, tapioca flour, amioca, and mixtures thereof.

29. The food product of claim 26 wherein the at least one flour comprises chickpea flour.

30. The food product of claim 29 wherein the at least one solid fat comprises coconut oil.

31. The food product of claim 29 wherein the filling further comprises at least one secondary flour selected from the group consisting of brown rice flour, buckwheat flour, quinoa flour, white rice flour, corn flour, and mixtures thereof.

32. The food product of claim 26 wherein the at least one flour comprises oat flour.

33. The food product of claim 32 wherein the at least one solid fat comprises coconut oil.

34. The food product of claim 26 wherein the at least one flour comprises pea flour.

35. The food product of claim 34 wherein the at least one solid fat comprises coconut oil.

36. The food product of claim 26 wherein the at least one flour comprises white lentil flour.

37. The food product of claim 36 wherein the at least one solid fat comprises coconut oil.

38. The food product of claim 26 wherein the at least one flour comprises coconut oil.

39. The process of claim 8 wherein the filling does not comprise peanut flour or almond flour.

40. The process of claim 11 wherein the filling does not comprise peanut flour or almond flour.

41. The process of claim 14 wherein the filling does not comprise peanut flour or almond flour.

42. The process of claim 17 wherein the filling does not comprise peanut flour or almond flour.

43. The ready to eat food product of claim 25 wherein the filling does not comprise peanut flour or almond flour.
